(19) United States
(12) Patent Application Publication
(10) Pub. No.: US 2026/0311516 A1
(43) Pub. Date: Oct. 8, 2026

(54) IMAGE PROCESSING APPARATUS, CONTROL METHOD FOR CONTROLLING IMAGE PROCESSING APPARATUS, AND STORAGE MEDIUM FOR OBTAINING SUITABLE IMAGES

(71) Applicant: CANON KABUSHIKI KAISHA, Tokyo (JP)

(72) Inventors: KUNIHIKO YAMAKAWA, Kanagawa (JP); HIROSHI SATO, Kanagawa (JP)

(21) Appl. No.: 19/357,747

(22) Filed: Oct. 14, 2025

(30) Foreign Application Priority Data
Oct. 15, 2024 (JP) 2024-179623

(51) Int. Cl. G06V 40/50; G06V 40/18; G06V 40/19; G06V 40/60

(52) U.S. Cl. CPC G06V 40/50; G06V 40/19; G06V 40/197; G06V 40/67

(57) ABSTRACT

An image processing apparatus includes an imaging unit configured to capture an eyeball image of a user, a first determination unit configured to determine whether a first eyeball image captured by the imaging unit satisfies a first condition, a second determination unit configured to determine whether a second eyeball image captured by the imaging unit satisfies a second condition, and an information presentation unit configured to, in a case where a user operation for registering the eyeball image is acquired, present first presentation information to the user in a case where the first condition is satisfied, and present second presentation information to the user in a case where the second condition is satisfied, and a registration unit configured to register the first or second eyeball image or an image feature acquired from the first or second eyeball image when the first or second condition is satisfied, respectively.

### BACKGROUND

### Field of the Technology

The present disclosure relates to an image processing apparatus, a control method for controlling an image processing apparatus, and a storage medium.

### Description of the Related Art

There is a case where an imaging apparatus used by being held in a hand authenticates a user by comparing an image registered in advance and an image obtained by an imaging unit that is built into the imaging apparatus and captures the user. Such authentication is completed only by an imaging unit capturing an image of a user and therefore is convenient. Thus, the authentication is used in a use case based on a user capturing an image that is suitable for the authentication, such as in the case of logging into an imaging apparatus or the like.

To correctly perform authentication using an image, it is necessary to determine that a person appearing in an image registered in advance (hereinafter referred to as a “registered image,” where necessary) and a person appearing in an image captured by an imaging unit (hereinafter referred to as an “authentication image,” where necessary) are the same person. Accordingly, conventionally, ingenuity is used to authenticate a user using iris authentication based on the iris of an eye and to make the appearances of the irises of eyes appearing in a registered image and an authentication image as similar to each other as possible. Japanese Patent Laid-Open No. 2015-170099 describes a technique for acquiring an authentication image that facilitates iris authentication by changing a user interface (UI) to be displayed according to the brightness of the environment when an authentication image that is an eye image of a user is acquired, or the size of the pupil in the authentication image.

If a change in visibility between a registered image and an authentication image is great, the authentication accuracy of the user decreases. In the conventional art, however, to maintain authentication accuracy, it is difficult to selectively acquire a registered image according to the situation where authentication is performed.

### SUMMARY

The present disclosure is directed to enabling the acquisition of a registered image according to the situation where authentication is performed.

According to an aspect of the present disclosure, an image processing apparatus includes at least one processor, and at least one memory having stored thereon instructions which, when executed by the at least one processor, cause the image processing apparatus to capture an eyeball image of a user, determine whether a captured first eyeball image satisfies a first condition, determine whether a captured second eyeball image satisfies a second condition, in a case where a user operation for registering the eyeball image is acquired, present first presentation information to the user in a case where the first condition is satisfied, and present second presentation information to the user in a case where the second condition is satisfied, in a case where it is determined that the first eyeball image satisfies the first condition, perform control to register at least one of the first eyeball image or an image feature that can be acquired from the first eyeball image and in a case where it is determined that the second eyeball image satisfies the second condition, perform control to register at least one of the second eyeball image or an image feature that can be acquired from the second eyeball image.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams illustrating examples of an external appearance of an imaging apparatus according to a first embodiment.

FIG. 2 is a diagram illustrating an example of an internal mechanism of the imaging apparatus according to the first embodiment.

FIG. 3 is a diagram illustrating an example of an electrical configuration of the imaging apparatus according to the first embodiment.

FIGS. 4A to 4D are diagrams illustrating examples of display screens of a display device of the imaging apparatus according to the first embodiment.

FIG. 5A is a diagram illustrating an example of a functional configuration of the imaging apparatus according to the first embodiment, FIG. 5B is a diagram illustrating an example of one of various tables managed by a registered data management section illustrated in FIG. 5A according to the first embodiment, FIG. 5C is a diagram illustrating an example of one of the various tables managed by the registered data management section illustrated in FIG. 5A according to the first embodiment, FIG. 5D is a diagram illustrating an example of one of the various tables managed by the registered data management section illustrated in FIG. 5A according to the first embodiment, and FIG. 5E is a diagram illustrating an example of a UI pattern table managed by an authentication state management section illustrated in FIG. 5A according to the first embodiment.

FIG. 6 is a flowchart illustrating an example of a detailed registration process procedure in a control method for controlling the imaging apparatus according to the first embodiment.

FIG. 7A illustrates an example of a first criterion and a second criterion, FIG. 7B illustrates an example of an image of the imaging apparatus, and FIG. 7C illustrates an example of an image of a display screen.

FIG. 8 is a flowchart illustrating an example of a detailed processing procedure of acquiring an eye image in step S605 in FIG. 6.

FIGS. 9A to 9E are examples of displays of line-of-sight guidance according to the first embodiment.

FIGS. 10A to 10J are examples of displays of line-of-sight guidance in a case of holding the imaging apparatus in a portrait position according to the first embodiment.

FIGS. 11A to 11E are examples of displays guiding an eye proximity position according to the first embodiment.

FIGS. 12A to 12C are examples of displays during an eye image acquisition process according to a second variation of the first embodiment.

FIG. 13 is a flowchart illustrating an example of an eye image acquisition process according to a third variation of the first embodiment.

FIGS. 14A and 14B are examples of displays of line-of-sight guidance according to the third variation of the first embodiment.

FIG. 15 is an example of a display of eye proximity position guidance according to a fourth variation of the first embodiment.

FIG. 16 is an example of a display of eye proximity position guidance including a current position according to the fourth variation of the first embodiment.

FIGS. 17A and 17B are examples of displays guiding an eye proximity distance and angle according to a fifth variation of the first embodiment.

FIG. 18 is a flowchart illustrating an example of a registration process in a control method for controlling an imaging apparatus according to a second embodiment.

FIG. 19 is an example of a display during an eye image acquisition process according to the second embodiment.

FIGS. 20A and 20B are examples of displays when acquisition of an eye image fails according to the second embodiment.

FIG. 21 is a flowchart illustrating an example of an eye image acquisition process according to a first variation of the second embodiment.

FIG. 22 is an example of a display during the eye image acquisition process according to the first variation of the second embodiment.

### DESCRIPTION OF THE EMBODIMENTS

With reference to the attached drawings, the present disclosure will be described in detail below based on its suitable embodiments. The configurations illustrated in the following embodiments are merely examples, and the present disclosure is not limited to the configurations illustrated in the figures.

With reference to the drawings, forms (embodiments) for carrying out the present disclosure will be described below.

### First Embodiment

First, a first embodiment is described.

In the present embodiment, a description is given of a form for, in an imaging apparatus having a first eyeball authentication function and a second eyeball authentication function on a user, acquiring eye images of the user to be used for the respective types of authentication as registered images. Further, a description is given of a form for acquiring eye images of the user suitable for the respective types of authentication as authentication images using the acquired registered images.

First eyeball authentication (hereinafter referred to simply as “first authentication”) is authentication performed when the user starts using the imaging apparatus and before an object image is captured based on an operation of the user. The first authentication is authentication that requires strictness. That is, when the first eyeball authentication function is executed, it is considered that an authentication image is acquired in a particular environment. Thus, as a registered image used for the first eyeball authentication function, it is necessary to register an image according to the situation where the first eyeball authentication function is executed.

On the other hand, second eyeball authentication (hereinafter referred to simply as “second authentication”) is authentication performed after the first authentication is performed and when the object image is captured based on the operation of the user (e.g., authentication performed according to the timing when the user presses a shutter button). In comparison to the first authentication, the second authentication is authentication required to hinder an imaging operation of the user as little as possible. That is, when the second eyeball authentication function is executed, it is considered that an authentication image is acquired in various environments. Thus, as a registered image used for the second eyeball authentication function, it is necessary to register images acquired in various environments.

### [Configuration of Imaging Apparatus (Camera)]

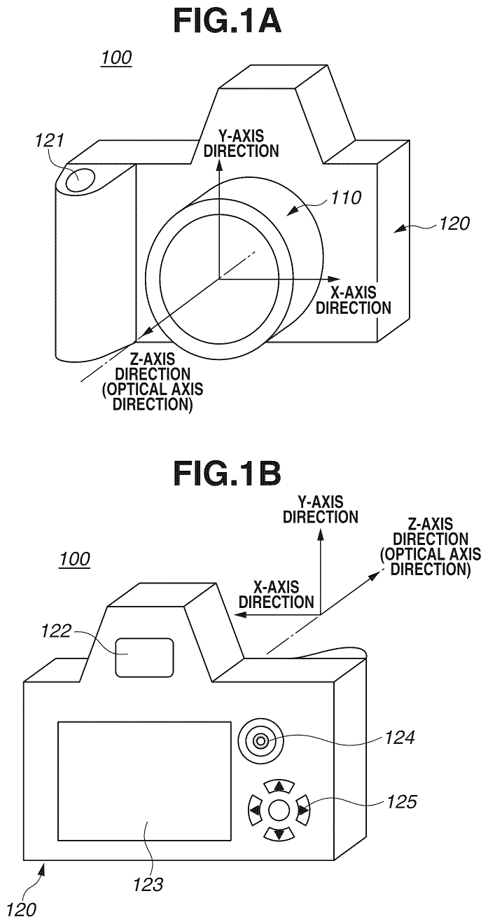

FIGS. 1A and 1B are diagrams illustrating examples of the external appearance of an imaging apparatus 100 according to the first embodiment. Specifically, as the imaging apparatus 100 according to the present embodiment, for example, an interchangeable lens digital still camera can be used. FIG. 1A is a front perspective view illustrating an example of the external appearance of the imaging apparatus 100 according to the first embodiment. FIG. 1B is a rear perspective view illustrating an example of the external appearance of the imaging apparatus 100 according to the first embodiment. In FIGS. 1A and 1B, the same components are designated by the same reference numbers. FIGS. 1A and 1B each illustrate an XYZ coordinate system where the optical axis direction of the imaging apparatus 100 is a Z-axis direction, and two directions orthogonal to the Z-axis direction and orthogonal to each other are an X-axis direction and a Y-axis direction.

As illustrated in FIG. 1A, the imaging apparatus 100 includes an imaging lens unit 110 and a camera housing 120. On the front surface of the camera housing 120, a shutter release button 121 as an operation member that receives an imaging operation from a user (a photographer) is placed.

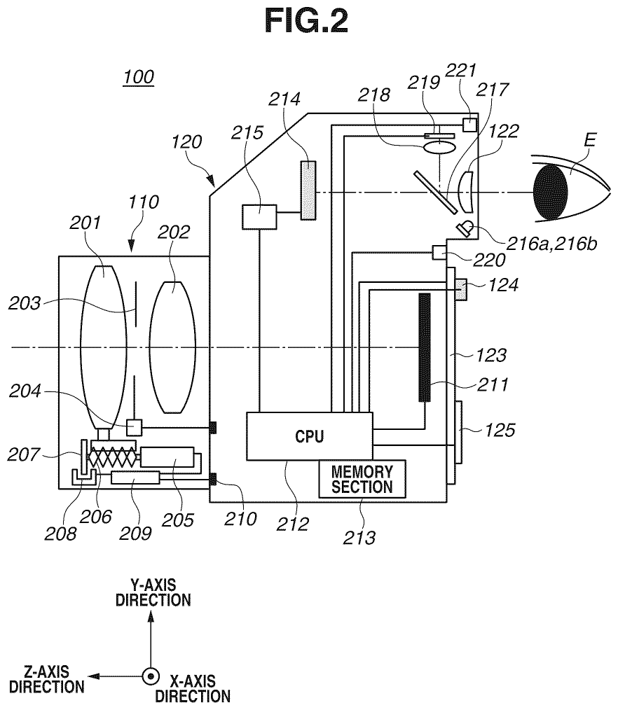

As illustrated in FIG. 1B, on the back surface of the camera housing 120, an eyepiece lens 122 (a viewfinder) into which the user looks to view a display device (a display device 214 in FIG. 2) included within the camera housing 120 is placed. Further, on the back surface of the camera housing 120, operation members 123 to 125, which receive various operations from the user, are also placed. For example, the operation member 123 is a touch panel that receives a touch operation. The operation member 124 is an operation lever that can be pushed down in directions. The operation member 125 is a four-direction key that can be pushed in in each of four directions. The operation member 123 that is the touch panel includes a display panel (e.g., a liquid crystal panel), and the display panel forms a back surface display of the imaging apparatus 100. The operation member 123 that is the touch panel has the function of displaying various images on the display panel.

FIG. 2 is a diagram illustrating an example of the internal mechanism of the imaging apparatus 100 according to the first embodiment. Specifically, FIG. 2 illustrates a cross-sectional view of the imaging apparatus 100 when cut along a YZ plane formed by the Y-axis direction and the Z-axis direction illustrated in FIG. 1A. In FIG. 2, the same components as the components illustrated in FIGS. 1A and 1B are designated by the same reference numbers and are not described in detail. FIG. 2 illustrates an XYZ coordinate system corresponding to the XYZ coordinate system illustrated in FIGS. 1A and 1B.

The imaging lens unit 110 includes lenses 201 and 202, a diaphragm 203, a diaphragm driving section 204, a lens driving motor 205, a lens driving member 206, a pulse plate 207, a photocoupler 208, a focus adjustment circuit 209, and a mount contact 210 as the internal mechanism.

The lens driving member 206 includes a driving gear. The photocoupler 208 detects the rotation of the pulse plate 207 that interlocks with the lens driving member 206. Then, the photocoupler 208 informs the focus adjustment circuit 209 of the detected rotation. The focus adjustment circuit 209 drives the lens driving motor 205 based on information from the photocoupler 208 and information from the camera housing 120 (information regarding the driving amount of the lens 201) and moves the lens 201, thereby changing an in-focus position. The mount contact 210 is an interface between the imaging lens unit 110 and the camera housing 120. Although FIG. 2 illustrates the two lenses 201 and 202 for simplicity, more than two lenses may be included within the imaging lens unit 110.

The camera housing 120 includes an imaging element 211, a central processing unit (CPU) 212, a memory section 213, a display device 214, a display device driving circuit 215, light sources 216a and 216b, a light divider 217, a light-receiving lens 218, and an eye imaging element 219 as the internal mechanism. Further, the camera housing 120 includes a loudspeaker 220 and an eye proximity sensor 221 as the internal mechanism.

The imaging element 211 is placed on a planned image forming plane of the imaging lens unit 110. The imaging element 211 is a component as an example of a first imaging unit that captures (images) an object based on an operation of the user and acquires an object image. The CPU 212 is a central processing unit of a microcomputer. The CPU 212 controls the operation of the entirety of the imaging apparatus 100 and performs various processes. The memory section 213 stores various pieces of information, programs executed when the CPU 212 performs the various processes, and the like. For example, the memory section 213 stores an object image captured (imaged) by the imaging element 211. The display device 214 displays various pieces of information on a screen (a display surface) of the display device 214. For example, the display device 214 is a liquid crystal panel and displays a captured image (an object image) on the screen. The display device driving circuit 215 drives the display device 214. An eye (eyeball) E of the user can view the screen of the display device 214 through the eyepiece lens 122.

The light sources 216a and 216b are light sources conventionally used in a single-lens reflex camera to detect the line of sight of the eye (eyeball) E based on the relationship between a reflection image obtained by corneal reflection of light (a corneal reflection image) and the pupil. Specifically, the light sources 216a and 216b are light sources for illuminating the eye (eyeball) E of the user looking into the viewfinder (the eyepiece lens 122). For example, the light sources 216a and 216b are infrared light-emitting diodes that emit infrared light insensitive to the eye (eyeball) E of the user and are placed near the eyepiece lens 122. An optical image of the eye (eyeball) E illuminated by the light sources 216a and 216b (an eye optical image; an optical image based on light emitted from the light sources 216a and 216b and reflected by the eye (eyeball) E) passes through the eyepiece lens 122 and is reflected by the light divider 217. Then, the eye optical image is formed by the light-receiving lens 218 on the eye imaging element 219 in which a plurality of photoelectric conversion elements (e.g., charge-coupled devices (CCDs) or complementary metal-oxide-semiconductors (CMOSs)) is two-dimensionally disposed. The light-receiving lens 218 positions the pupil of the eye (eyeball) E of the user and the eye imaging element 219 in a conjugate image formation relationship. A line-of-sight detection process is performed, whereby the line of sight of the eye (eyeball) E is detected based on the position of a corneal reflection image in the eye optical image formed on the eye imaging element 219. For example, as information regarding the line of sight, at least one of information indicating the line-of-sight direction or information indicating a viewpoint (the position gazed at by the user) on the screen of the display device 214 is obtained. The viewpoint can be regarded as the position that the user is viewing or regarded as the line-of-sight position. The eye imaging element 219 is a component as an example of a second imaging unit that captures (images) an eye image including the eye (eyeball) E of the user as an authentication image.

The loudspeaker 220 is a component as an example of a sound output unit that reproduces and outputs a shutter sound or voice guidance. The eye proximity sensor 221 is a component that acquires eye proximity information regarding the eye (eyeball) E of the user as the state of the eye (eyeball) E of the user. For example, the eye proximity sensor 221 measures the eye proximity distance of the user that is the distance from the eye proximity sensor 221 to the eye (eyeball) E of the user, as an example of the eye proximity information. Then, the eye proximity sensor 221 detects whether the user is looking into the viewfinder (the eyepiece lens 122).

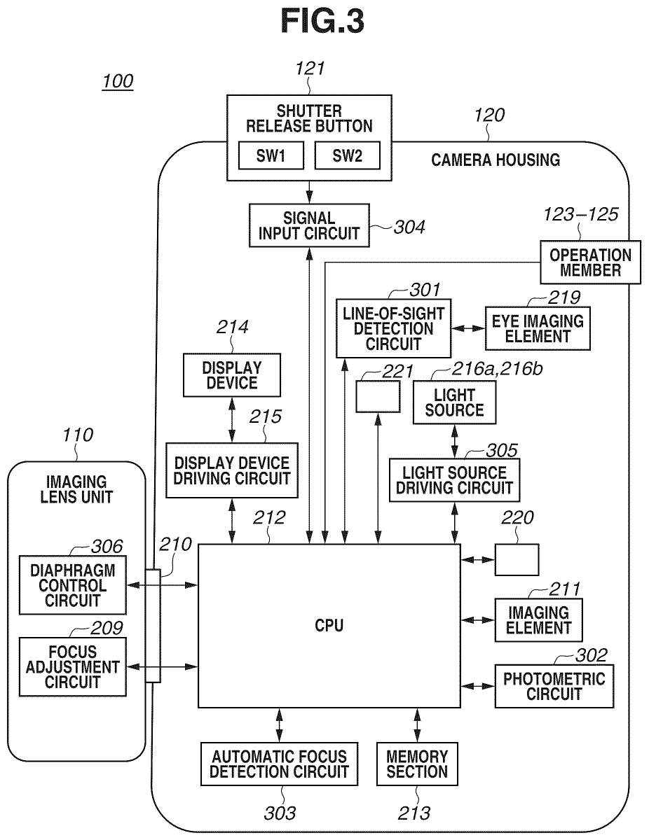

FIG. 3 is a diagram illustrating an example of the electrical configuration of the imaging apparatus 100 according to the first embodiment. In FIG. 3, the same components as the components illustrated in FIGS. 1A, 1B, and 2 are designated by the same reference numbers, and are not described in detail.

The imaging lens unit 110 includes the focus adjustment circuit 209 illustrated in FIG. 2 and a diaphragm control circuit 306 as the electrical configuration.

The camera housing 120 includes the shutter release button 121 and the operation members 123 to 125 in FIGS. 1A and 1B as the electrical configuration. The camera housing 120 also includes the imaging element 211, the CPU 212, the memory section 213, the display device 214, the display device driving circuit 215, the light sources 216a and 216b, the eye imaging element 219, the loudspeaker 220, and the eye proximity sensor 221 in FIG. 2 as the electrical configuration. Further, as illustrated in FIG. 3, the camera housing 120 includes a line-of-sight detection circuit 301, a photometric circuit 302, an automatic focus detection circuit 303, a signal input circuit 304, and a light source driving circuit 305 as the electrical configuration.

As illustrated in FIG. 3, the CPU 212 is connected to the line-of-sight detection circuit 301, the photometric circuit 302, the automatic focus detection circuit 303, the signal input circuit 304, and the light source driving circuit 305. Further, as illustrated in FIG. 3, the CPU 212 is connected to the imaging element 211, the memory section 213, the display device driving circuit 215, the loudspeaker 220, the eye proximity sensor 221, and the operation members 123 to 125. The CPU 212 transmits signals to the focus adjustment circuit 209 placed in the imaging lens unit 110 and the diaphragm control circuit 306 included in the diaphragm driving section 204 in the imaging lens unit 110 via the mount contact 210. For example, the memory section 213 accompanying the CPU 212 has the function of storing imaging signals from the imaging element 211 and the eye imaging element 219.

The line-of-sight detection circuit 301 performs analog-to-digital (A/D) conversion on an output of the eye imaging element 219 (an eye image obtained by capturing the eye (eyeball) E of the user) in the state where an eye optical image is formed on the eye imaging element 219. Then, the line-of-sight detection circuit 301 transmits the result of the A/D conversion to the CPU 212. The CPU 212 extracts a feature point necessary for the detection of the line of sight from the eye image according to a line-of-sight detection process and detects the line of sight of the user based on the position of the feature point.

The photometric circuit 302 performs predetermined processes (e.g., amplification, logarithmic compression, and A/D conversion) on a signal, such as a luminance signal corresponding to the brightness of an object field, obtained from the imaging element 211 that doubles as a photometric sensor. Then, the photometric circuit 302 sends the results of the predetermined processes as object field luminance information to the CPU 212.

The automatic focus detection circuit 303 performs A/D conversion on signals from a plurality of detection elements (a plurality of pixels) included in the imaging element 211 and used for phase difference detection and sends the results of the A/D conversion to the CPU 212. The CPU 212 calculates the distances to an object corresponding to focus detection points from the signals of the plurality of detection elements. This is a known technique termed imaging plane phase difference autofocus (AF).

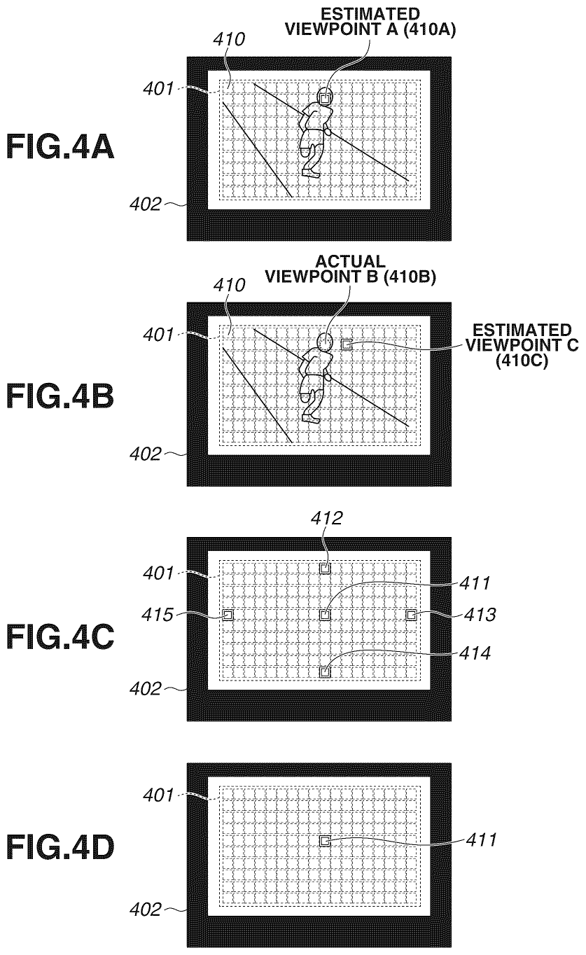

FIGS. 4A to 4D are diagrams illustrating examples of display screens of the display device 214.

As an example, in the present embodiment, the focus detection points mentioned in the description of the automatic focus detection circuit 303 are present at 180 places on an imaging surface corresponding to 180 places indicated on the screen of the display device 214 (an in-viewfinder field of view) illustrated in FIG. 4A. FIG. 4A illustrates the state where the display device 214 operates (the state where the display device 214 displays an image), and the in-viewfinder field of view includes a focus detection area 401, a field-of-view mask 402, and 180 distance measurement point indicators 410 in the focus detection area 401. Each of the distance measurement point indicators 410 illustrated in FIG. 4A is displayed in a superimposed manner on a through image (a live view image) displayed on the display device 214 so that the distance measurement point indicator 410 is displayed at a position corresponding to a focus detection point on the imaging surface. Among the 180 distance measurement point indicators 410 illustrated in FIG. 4A, a distance measurement point indicator 410A corresponding to a current viewpoint A (an estimated position) is highlighted, for example, with a frame. There is a case where the viewpoint cannot be estimated with high accuracy due to a factor such as the individual difference in the shape of the human eye E. Specifically, as illustrated in FIG. 4B, a shift can occur between an actual viewpoint B (410B) and an estimated viewpoint C (410C).

The description returns to FIG. 3.

To the signal input circuit 304, a switch SW1 and a switch SW2 of the shutter release button 121 are connected. The switch SW1 is a switch that is turned on by a first stroke on the shutter release button 121 and starts an imaging preparation operation (e.g., photometry and distance measurement) of the imaging apparatus 100. The switch SW2 is a switch that is turned on by a second stroke on the shutter release button 121 and starts an imaging operation. If on signals from the switches SW1 and SW2 of the shutter release button 121 are input to the signal input circuit 304, the signal input circuit 304 transmits the input on signals to the CPU 212. If the switch SW1 of the shutter release button 121 is turned on, the detection of the line of sight of the user may be started.

The light source driving circuit 305 drives the light sources 216a and 216b.

Further, if the user operates the operation members 123 to 125, the operation members 123 to 125 output operation signals according to the operations of the user to the CPU 212. Then, the CPU 212 performs processing (control) according to the operation signals. For example, the CPU 212 moves a selection frame for a displayed menu according to an operation signal.

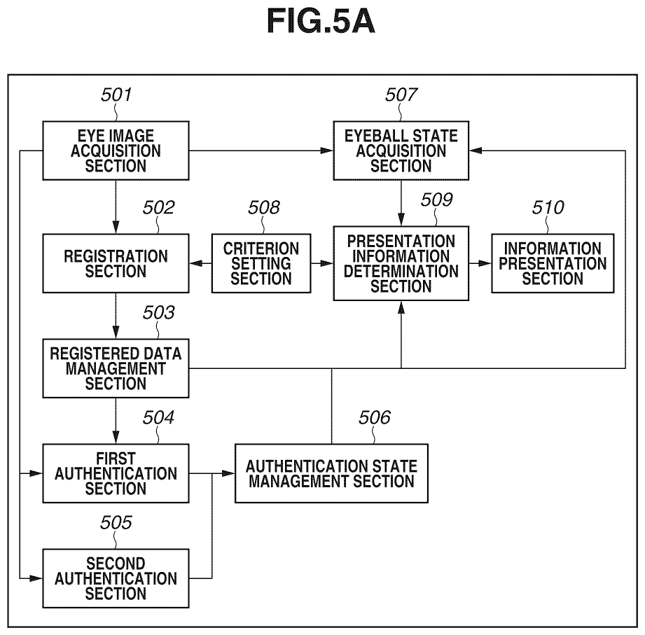

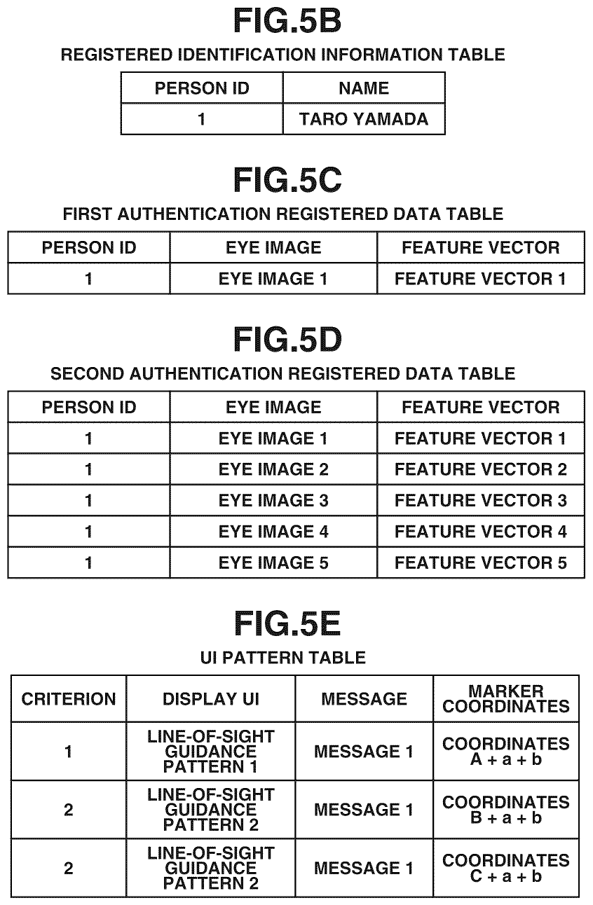

FIG. 5A is a diagram illustrating an example of the functional configuration of the imaging apparatus 100 according to the first embodiment. The imaging apparatus 100 is an imaging apparatus that authenticates the user. The imaging apparatus 100 includes an eye image acquisition section 501, a registration section 502, a registered data management section 503, a first authentication section 504, a second authentication section 505, and an authentication state management section 506 as the functional configuration. Further, the imaging apparatus 100 includes an eyeball state acquisition section 507, a criterion setting section 508, a presentation information determination section 509, and an information presentation section 510 as the functional configuration. The functional components (501 to 510) illustrated in FIGS. 5A to 5E are, for example, achieved by the CPU 212 illustrated in FIGS. 2 and 3 executing programs stored in the memory section 213 illustrated in FIGS. 2 and 3.

In the present embodiment, as individual authentication of the user, based on the eye (eyeball) E of the user looking into the viewfinder (the eyepiece lens 122), the imaging apparatus 100 authenticates whether the user is a registered person. Particularly, the imaging apparatus 100 performs the first authentication before the user captures an object using the imaging apparatus 100 and further performs the second authentication when the user captures the object using the imaging apparatus 100 (e.g., when the user captures the object). Then, in the present embodiment, the imaging apparatus 100 stores the results of these types of authentication with the captured image.

The eye image acquisition section 501 is an eye image acquisition unit that acquires an eye image including the eye (eyeball) E of the user looking into the viewfinder (the eyepiece lens 122). Specifically, the eye image acquisition section 501 acquires an eye image (an eye image signal; an electric signal of an eye image) from the eye imaging element 219 illustrated in FIG. 3 via the line-of-sight detection circuit 301. In the present embodiment, in the case of a registration process for registering a registered user, the eye image acquisition section 501 acquires an eye image as a registered image. In the case of an authentication process for authenticating an authentication target user, the eye image acquisition section 501 acquires an eye image as an authentication image.

The registration section 502 is a registration unit that creates data to be registered in the registered data management section 503 based on an eye image of a registered user acquired by the eye image acquisition section 501.

The registered data management section 503 is a registered data management unit that manages authentication registration information regarding a user permitted to use the imaging apparatus 100. Specifically, the registered data management section 503 holds an eye image of a registered user that is a registered eye image acquired in advance, a feature vector calculated from the eye image of the registered user, and the position of an indicator corresponding to the feature vector in association with the name and the person identifier (ID) of the registered user in the memory section 213. In the present embodiment, at the beginning of a registration process, a registered user inputs their name, and the registered data management section 503 manages the input name (and the person ID) of the registered user in association with registered data in a table.

FIGS. 5B to 5D are diagrams illustrating examples of various tables managed by the registered data management section 503 illustrated in FIG. 5A according to the first embodiment. Specifically, a registered identification information table 520 illustrated in FIG. 5B is a table where a person ID and the name of a registered user are associated with each other. A first authentication registered data table 530 illustrated in FIG. 5C is a table where a person ID, an eye image of a registered user used by the first authentication section 504, a feature vector used by the first authentication section 504, and the position of an indicator corresponding to the feature vector are associated with each other. A second authentication registered data table 540 illustrated in FIG. 5D is a table where a person ID, an eye image of a registered user used by the second authentication section 505, a feature vector used by the second authentication section 505, and the position of an indicator corresponding to the feature vector are associated with each other.

The various tables 520 to 540 illustrated in FIGS. 5B to 5D associate information regarding the same registered user based on the person ID. For example, a neural network is used to extract a feature vector, and the extracted feature vector is used to individually authenticate the user.

The method for individually authenticating the user using an eye image is not limited to the above method using a neural network, and for example, a known method such as iris authentication or the like may be used.

FIG. 5E is a diagram illustrating an example of a UI pattern table, which is a table for managing patterns of display UIs, according to the first embodiment. Similar to the various tables 520 to 540 illustrated in FIGS. 5B to 5D, an authentication state table, which is not shown in the figure, also associates information regarding the same registered user based on the person ID.

The description returns to FIG. 5A.

The first authentication section 504 is a first authentication unit that, before an object image is captured by the imaging element 211, authenticates an authentication target user based on an eye image of the authentication target user (an authentication image) obtained by the eye imaging element 219 and acquired by the eye image acquisition section 501. In the present embodiment, when an object image is not captured by the imaging element 211, the first authentication section 504 performs the process of authenticating whether an authentication target user is a person registered in the registered data management section 503 (a registered user).

The second authentication section 505 is a second authentication unit that, when an object image is captured by the imaging element 211, authenticates an authentication target user based on an eye image of the authentication target user (an authentication image) obtained by the eye imaging element 219 and acquired by the eye image acquisition section 501. In the present embodiment, when an object image is captured by the imaging element 211, the second authentication section 505 performs the process of authenticating whether a person authenticated by the first authentication section 504 (an authentication target user) is capturing the object image. The second authentication section 505 also performs control to continue the authentication state of the second authentication only during the capturing of the object image.

In the present embodiment, it is desirable that the first authentication section 504 should use an authentication setting in which the false acceptance rate is low. On the other hand, it is desirable that the second authentication section 505 should use an authentication setting in which the false rejection rate is low. As a method for achieving such authentication settings, for example, there is a method for changing a threshold for the degree of similarity when the same authentication method is used by the first authentication section 504 and the second authentication section 505. In this case, specifically, a threshold for a high degree of similarity is set in the first authentication section 504, and a threshold for a low degree of similarity is set in the second authentication section 505. Consequently, it is possible to lower the false acceptance rate in the first authentication section 504 and lower the false rejection rate in the second authentication section 505. Based on the above, when it is difficult to simultaneously lower both the false acceptance rate and the false rejection rate only when an image is captured, it is possible to achieve this by performing two-step authentication.

The authentication state management section 506 is an authentication state management unit that manages the authentication state of the first authentication performed by the first authentication section 504 and the authentication state of the second authentication performed by the second authentication section 505. Additionally, the authentication state management section 506 also manages the presence or absence of use by another person. For example, the authentication state management section 506 holds the UI pattern table illustrated in FIG. 5E in the memory section 213 and executes the management.

The UI pattern table in FIG. 5E is a table for managing patterns of display UIs. Depending on the criteria, the pattern type of the UI to be displayed, the display message, and, if guiding the user's gaze is required, the coordinates of the marker are linked. Here, “a” and “b” in the marker coordinate field of FIG. 5E represent variables used to adjust the marker's display coordinates. Specifically, “a” is based on the current gaze information obtained by the eyeball state acquisition section 507, while “b” is based on the data of a registered image.

The authentication state table, not shown in the figure, is described.

“First authentication state” in the authentication state table indicates the current state of the first authentication performed by the first authentication section 504, and takes any of values “not authenticated,” “authentication failure,” or “authentication success.” “Person ID” is the ID of a person identified by the first authentication. If “first authentication state” is “not authenticated”, “person ID” has a value indicating emptiness such as NULL or the like. “Second authentication state” in the authentication state table indicates the current state of the second authentication performed by the second authentication section 505, and takes any of values “not authenticated,” “authentication failure,” or “authentication success.” “Number of failures of first authentication” in the authentication state table indicates the number of failures of the first authentication performed by the first authentication section 504 and takes an integer value greater than or equal to 0. “Number of failures of second authentication” in the authentication state table indicates the number of failures of the second authentication performed by the second authentication section 505 and takes an integer value greater than or equal to 0. The authentication state table is stored and held in the memory section 213. The method for holding the authentication state table is not limited to a table structure, and for example, may be a key-value structure or the like.

The eyeball state acquisition section 507 is an eyeball state acquisition unit that acquires the state of the eye (eyeball) E of the user based on an eye image acquired by the eye image acquisition section 501 or an eye image saved in the registered data management section 503. For example, the state of the eyeball of the user is line-of-sight information regarding the user. For example, the line of sight of the user is detected by, through the use of a method described in Japanese Patent Laid-Open No. 2024-2562, obtaining the coordinates of a corneal reflection image of the light sources 216a and 216b observed on an eye image and the pupil center and obtaining the gaze coordinates of the user on the display device 214 based on the obtained coordinates. For example, if the line of sight of the user looking into the viewfinder (the eyepiece lens 122) is acquired, it is possible to present how to move the line of sight from the current line-of-sight position to obtain a registered image and an authentication image suitable for authentication to the user by a user interface (UI) display. The line-of-sight information acquired as the state of the eye (eyeball) E of the user by the eyeball state acquisition section 507 includes the line-of-sight direction of the user. In this case, the eyeball state acquisition section 507 includes a line-of-sight sensor that acquires the line-of-sight information regarding the user. The state of the eye (eyeball) E of the user acquired by the eyeball state acquisition section 507 is not limited to the line-of-sight information regarding the user. For example, the state of the eye (eyeball) E of the user acquired by the eyeball state acquisition section 507 includes eye proximity information regarding the user. In this case, the eyeball state acquisition section 507 includes the eye proximity sensor 221 that acquires the eye proximity information regarding the user. For example, the state of the eye (eyeball) E of the user acquired by the eyeball state acquisition section 507 includes eye image information obtained by performing image processing on an eye image acquired by the eye image acquisition section 501 or an eye image saved in the registered data management section 503. At this time, for example, the eye image information can include information such as the degree of opening of the eyelid or the pupil of the user, the eye proximity position or the eye proximity angle of the user, the presence or absence of the wearing of eyewear, and the like.

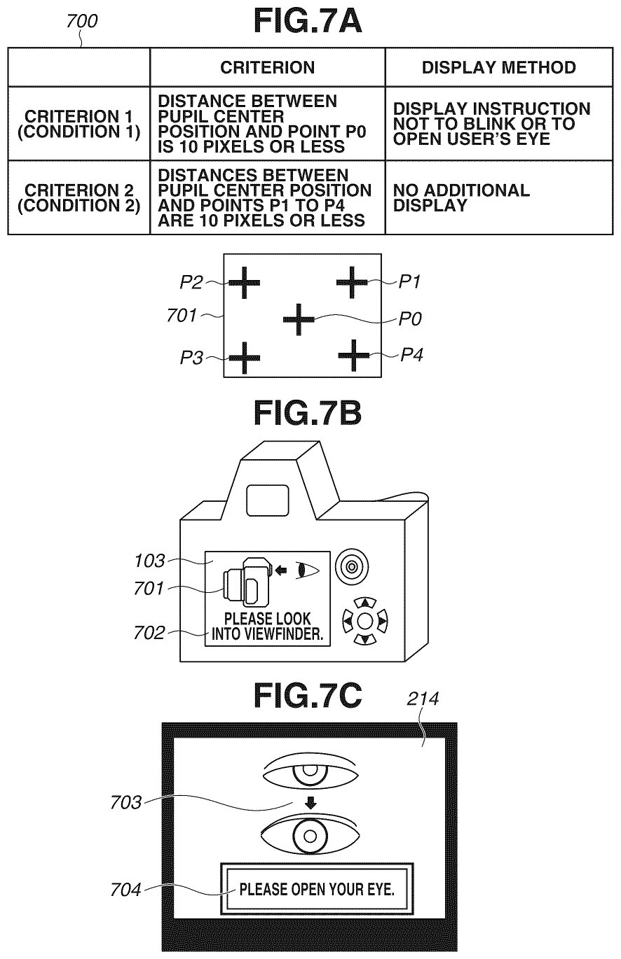

The criterion setting section 508 sets a criterion for an eye image to be registered in the registered data management section 503 based on an eye image acquired by the eye image acquisition section 501. A plurality of criteria can be set, and the registered data management section 503 determines whether to register an eye image with respect to each criterion (condition). The criteria will be specifically described below with reference to examples of the criteria in FIG. 7A.

The presentation information determination section 509 is a first determination unit that, when the eye imaging element 219 captures an eye image in a case where the first authentication section 504 authenticates the user, determines first presentation information including guidance information for guiding at least one of the position or the direction of the eye (eyeball) E of the user. At this time, for example, the presentation information determination section 509 can determine the first presentation information based on criteria (conditions) set by the criterion setting section 508 and the state of the current eye (eyeball) E of the user acquired by the eyeball state acquisition section 507. For example, the presentation information determination section 509 also determines UI information so that the eye image acquisition section 501 can acquire an eye image satisfying a first criterion (condition) to be used for the first authentication or a second criterion (condition) to be used for the second authentication as the first presentation information. In the present embodiment, the presentation information determination section 509 selects appropriate information from criteria set by the criterion setting section 508 and presentation information including a plurality of display UIs and a plurality of types of voice guidance stored in the memory section 213 and determines the first presentation information or second presentation information. The presentation information determination section 509 can also make the above selection from the presentation information stored in the memory section 213 based on the authentication state of the first authentication managed by the authentication state management section 506 or an eye image acquired by the eye image acquisition section 501 in the first authentication. Similarly, the presentation information determination section 509 can make the above selection from the presentation information stored in the memory section 213 based on the authentication state of the second authentication managed by the authentication state management section 506 or an eye image acquired by the eye image acquisition section 501 in the second authentication. Further, the presentation information determination section 509 selects information to be presented based on the state of the eye (eyeball) E of the user acquired by the eyeball state acquisition section 507 in the first authentication or the second authentication or an already registered eye image registered in the registered data management section 503.

The information presentation section 510 is an information presentation unit that, when a user operation for registering a registered image is received, presents the first presentation information or the second presentation information determined by the presentation information determination section 509 based on the criterion setting section 508 to the user. The information presentation section 510 is also an information presentation unit that, when the eye imaging element 219 captures an eye image in a case where the first authentication section 504 and the second authentication section 505 authenticate the user, presents the presentation information determined by the presentation information determination section 509 to the user. For example, the information presentation section 510 that performs the process of presenting the first presentation information and the second presentation information is composed of at least one of a display unit that is the display device 214 or the operation member 123 such as the touch panel or the like, or a sound output unit that is the loudspeaker 220. Then, the information presentation section 510 displays UIs of the first presentation information and the second presentation information on the display unit or outputs sounds of the first presentation information and the second presentation information using voice guidance from the sound output unit.

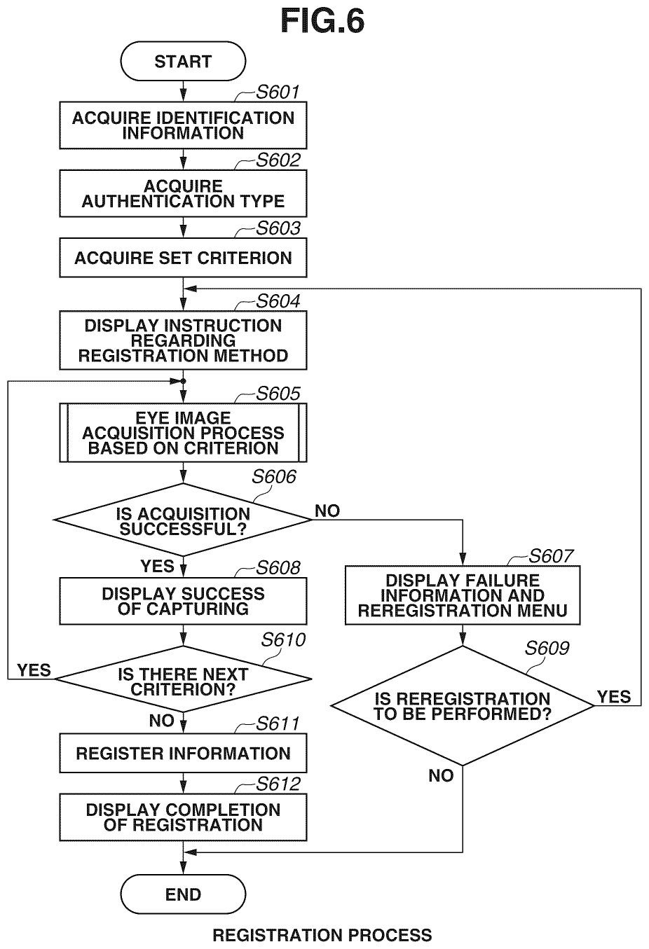

FIG. 6 is a flowchart illustrating an example of the detailed registration process procedure in a control method for controlling the imaging apparatus 100 according to the first embodiment. The processing in the flowchart illustrated in FIG. 6 is mainly executed by the registration section 502 in the CPU 212. It is assumed that the processing in the flowchart illustrated in FIG. 6 is performed by the user operating the imaging apparatus 100 at a time other than when an image is captured. Thus, the processing in the flowchart illustrated in FIG. 6 is executed when the user calls the processing from a menu or the like by operating the imaging apparatus 100. For example, the processing is executed when a menu screen (not illustrated) or the like is displayed on the touch panel (the operation member 123) of the imaging apparatus 100, and the user selects a menu for calling the processing by operating the operation members 123 to 125 on the menu screen or the like.

First, in step S601 in FIG. 6, the registration section 502 receives the input of identification information regarding a person to be registered (a registered user). In the present embodiment, the registration section 502 receives the input of a “name”. Specifically, the information presentation section 510 displays a screen for inputting the name (not illustrated) on the touch panel (the operation member 123), and the registration section 502 receives the input of the name by the user operating the operation members 123 to 125. When the user completes the input, the user presses a “completed” button or the like displayed on the screen, thereby notifying the registration section 502 that the input of the name is completed. Then, the processing proceeds to step S602.

In step S602, the registration section 502 receives an input indicating for which of the two different types of authentication, namely the first eyeball authentication or the second eyeball authentication, an eye image to be registered in the camera is to be used. Specifically, the information presentation section 510 displays a graphical user interface (GUI) for selecting authentication (not illustrated) on the touch panel (the operation member 123), and the registration section 502 receives an operation of the user. If the registration section 502 receives the selection of either of the authentication types from the user by the user touching the GUI such as a button or the like, the processing proceeds to step S603.

In step S603 in FIG. 6, the registration section 502 acquires a setting regarding a registration criterion (a registration condition) for an eye image. That is, the registration section 502 acquires a criterion (condition) for an eye image to be registered as a registered image for each of the two different types of authentication, namely the first eyeball authentication or the second eyeball authentication, in the camera. Criteria are set in advance according to the purposes of the use of the camera by an administrator user. For example, a user who does not wish to impair usability during imaging selects a criterion for increasing the number of registered images or variations of the number of registered images. Alternatively, a criterion preset in advance before shipment from the factory may be used without the user selecting the criterion. In step S603, the registration section 502 acquires a criterion associated with the authentication type selected in step S602. After the acquisition, the processing proceeds to step S604.

FIG. 7A illustrates examples of the first criterion (the first condition) and the second criterion (the second condition). In FIG. 7A, a table 700 illustrates examples of the first and second criteria. An image 701 is obtained by displaying points P0 to P4 of which the coordinates are determined in advance in a superimposed manner on an image acquired when the user looks into the viewfinder of the camera (hereinafter referred to as a “camera image”). In the present embodiment, the first criterion is “the distance between the center point P0 and the pupil center position in the camera image is 10 pixels or less,” and an image in which the pupil center appears near the center of the camera image is registered as a first image. The second criterion is “the distances between the points P1 to P4 and the pupil center position in the camera image are 10 pixels or less,” and an image in which the pupil center appears near the points P1 to P4 is registered as a second image. That is, a registration criterion is set according to the distance between the position of the detected pupil and a predetermined position. The first criterion used for the first authentication is set so that the distance between the position of the pupil and the predetermined position is less than or equal to a predetermined distance. Although in the above description, the value “10 pixels or less” is set, the present disclosure is not limited to this. Another value may be set, or a value may be appropriately set according to the resolution of the camera image, the detection accuracy of the pupil center, or the like. Alternatively, a criterion regarding the number of captured images may be provided. The present embodiment is described based on the assumption that a criterion (a condition) and content to be displayed to the user are stored in association with each of the first and second criteria.

Next, in step S604 in FIG. 6, based on the registration criterion acquired in step S603, the information presentation section 510 displays a registration method for registering an eye image to the user. Specifically, the information presentation section 510 displays an instruction to look into the viewfinder to the user on the touch panel (the operation member 123). The information presentation section 510 also displays an instruction to view an indicator in the viewfinder. Additionally, according to the criterion acquired in step S603, the presentation information determination section 509 determines information to be presented. Further, the information presentation section 510 displays the determined information. For example, the information presentation section 510 displays an instruction, for example, not to blink or to open the user's eye so that a desirable eye image can be captured.

Next, by the processes of steps S605 to S611 in FIG. 6, the information presentation section 510 displays indicators 411 to 415 illustrated in in FIG. 4C in order on the display device 214. Then, the registered data management section 503 stores an eye image of the user viewing each of the displayed indicators 411 to 415, a feature vector obtained from each eye image, and the position of the indicator. The processes are described in order.

In step S605 in FIG. 6, the information presentation section 510 displays an indicator on the display device 214. Specifically, the information presentation section 510 displays only the indicator 411 illustrated in FIG. 4C and does not display the other indicators. Alternatively, for example, the information presentation section 510 may display all the indicators 411 to 415 illustrated in FIG. 4C and display only the indicator 411 with a highlighted color. Alternatively, another display method may be employed so long as the display can inform the user that the user is requested to view the indicator 411.

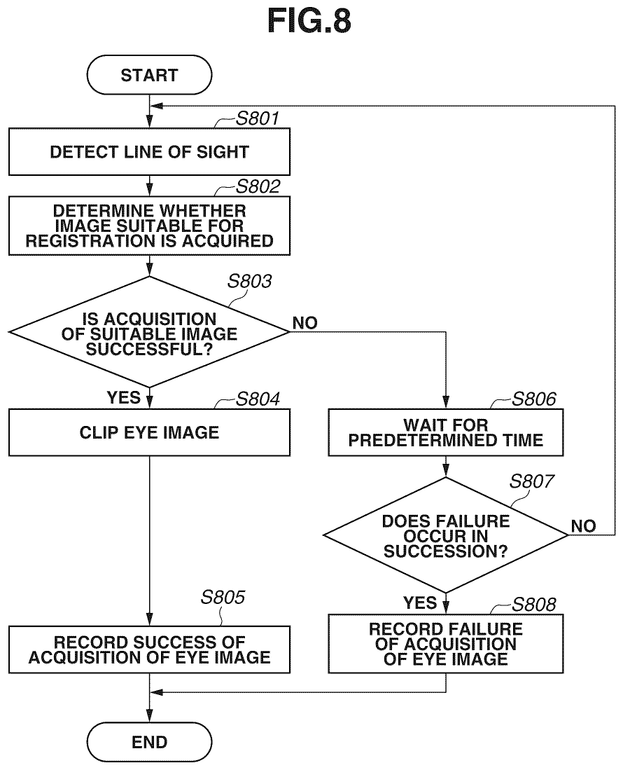

Next, in step S605 in FIG. 6, the eye image acquisition section 501 acquires an eye image when the user looks into the viewfinder (the eyepiece lens 122). The detailed processing of step S605 in FIG. 6 is described with reference to FIG. 8.

FIG. 8 is a flowchart illustrating an example of the detailed processing procedure of acquiring an eye image in step S605 in FIG. 6. The processing in the flowchart illustrated in FIG. 8 is mainly executed by the eye image acquisition section 501 in the CPU 212.

First, in step S801 in FIG. 8, the eye image acquisition section 501 executes a line-of-sight detection process for detecting the line of sight of the user. As the line-of-sight detection process for detecting the line of sight of the user in this step, for example, through the use of the method described in Japanese Patent Laid-Open No. 2024-2562, the eye image acquisition section 501 can perform the process of obtaining the coordinates of a corneal reflection image of the light sources 216a and 216b observed on an eye image and the pupil center, and obtaining the gaze coordinates of the user on the display device 214 based on the obtained coordinates.

Next, in step S802 in FIG. 8, the eye image acquisition section 501 determines whether an eye image satisfying the registration criterion to be used for the authentication is acquired. Specifically, based on whether the line-of-sight detection process in step S801 is successful, the eye image acquisition section 501 determines whether an eye image suitable for the registration to be used for the authentication is acquired. For example, in the line-of-sight detection process in step S801, the eye image acquisition section 501 acquires an eye image (an eye image signal; an electric signal of an eye image) from the eye imaging element 219 via the line-of-sight detection circuit 301. Next, the eye image acquisition section 501 obtains the coordinates of a corneal reflection image of the light sources 216a and 216b observed on the eye image and the pupil center. Next, the eye image acquisition section 501 obtains the gaze coordinates of the user on the display device 214 based on the obtained coordinates. Then, if the coordinates of the pupil center or the like are not detected, the eye image acquisition section 501 determines the line-of-sight detection process is a failure. Thus, in the process of obtaining the coordinates of the pupil center and the like, if these coordinates are not obtained, the eye image acquisition section 501 may determine that an eye image suitable for the authentication is not acquired.

Next, in step S803 in FIG. 8, based on the result of the determination in step S802, the eye image acquisition section 501 determines whether the acquisition of an eye image suitable for the authentication is successful.

In step S803 in FIG. 8, if the eye image acquisition section 501 determines that the acquisition of an eye image suitable for the registration to be used for the authentication is successful (YES in step S803), the processing proceeds to step S804.

In step S804 in FIG. 8, the eye image acquisition section 501 clips and acquires an eye image. Specifically, first, the eye image acquisition section 501 obtains the eye image acquired in step S802 in FIG. 8. Then, using the coordinates of a pupil center image c′ obtained in step S803 in FIG. 8, the eye image acquisition section 501 crops a certain size so that the pupil center image c′ is the center of the image. Further, the eye image acquisition section 501 generates and acquires an eye image resized to the input size of a neural network to be used to extract a feature vector.

Next, in step S805 in FIG. 8, the eye image acquisition section 501 records the success of the acquisition of an eye image using a flag or the like.

In step S803 in FIG. 8, if the eye image acquisition section 501 determines that the acquisition of an eye image suitable for the authentication is not successful (fails) (NO in step S803), the processing proceeds to step S806.

In step S806 in FIG. 8, the eye image acquisition section 501 performs the process of waiting for a predetermined amount of time, such as several hundreds of milliseconds. The process of step S806 is the process of expecting that an eye image changes and the detection of the line of sight is successful.

Next, in step S807 in FIG. 8, the eye image acquisition section 501 determines whether the acquisition of an eye image suitable for the authentication fails the number of times determined in advance in succession. The “failure” means a case where it is determined in step S803 in FIG. 8 that an eye image suitable for the authentication is not acquired (NO in step S803).

In step S807 in FIG. 8, if the eye image acquisition section 501 determines that the acquisition of an eye image suitable for the authentication does not fail the number of times determined in advance in succession (NO in step S807), the processing returns to step S801. Then, the processes of step S801 and the subsequent steps are performed again.

In step S807 in FIG. 8, if the eye image acquisition section 501 determines that the acquisition of an eye image suitable for the authentication fails the number of times determined in advance in succession (YES in step S807), the processing proceeds to step S808.

In step S808 in FIG. 8, the eye image acquisition section 501 records the failure of the acquisition of an eye image using a flag or the like. At this time, the eye image acquisition section 501 may further record the eye image acquired in step S802 in FIG. 8.

If the process of step S805 in FIG. 8 ends, or if the process of step S808 in FIG. 8 ends, the processing of the flowchart in FIG. 8 ends. Then, if the processing of the flowchart in FIG. 8 ends, the process of acquiring an eye image in step S605 in FIG. 6 ends.

The description returns to FIG. 6.

If the process of step S605 in FIG. 6 ends, the processing proceeds to step S606.

In step S606 in FIG. 6, the eye image acquisition section 501 determines whether the acquisition of an eye image is successful. Specifically, based on the flag recorded in step S805 or S808 in FIG. 8, the eye image acquisition section 501 determines whether the acquisition of an eye image is successful.

In step S606 in FIG. 6, if the eye image acquisition section 501 determines that the acquisition of an eye image is successful (YES in step S606), the processing proceeds to step S608.

In step S608 in FIG. 6, the eye image acquisition section 501 or the registration section 502 extracts a feature vector from the eye image acquired in step S605 in FIG. 6 as authentication registration information for authenticating the user. For example, a neural network is used to extract a feature vector, and the extracted feature vector is used to individually authenticate the user. The method for individually authenticating the user using the eye image is not limited to the above method using the neural network, and for example, a known method such as iris authentication or the like may be used.

Next, in step S608 in FIG. 6, the information presentation section 510 displays on the display device 214 the success of the capturing of an eye image with the indicator that is being displayed on the display device 214. For example, the information presentation section 510 may display a message “the capturing of an eye image is successful” or the like or may display an icon indicating that the capturing of an eye image is successful or the like on the display device 214.

In step S606 in FIG. 6, if the eye image acquisition section 501 determines that the acquisition of an eye image is not successful (fails) (NO in step S606), the processing proceeds to step S607.

In step S607 in FIG. 6, the information presentation section 510 displays on the display device 214 the failure of the capturing of an eye image using the indicator that is being displayed on the display device 214. For example, the information presentation section 510 may display a message “the capturing of an eye image fails” or the like or may display an icon indicating that the capturing of an eye image fails or the like on the display device 214.

If the process of step S607 in FIG. 6 ends, the processing proceeds to step S609.

In step S609 in FIG. 6, the registration section 502 determines whether to perform reregistration.

Specifically, if an operation regarding continuation is acquired from the user, the registration section 502 determines that that reregistration is to be performed. Then, the processing returns to step S604. If an operation of the user is not acquired, or if a user operation for ending this control is received, the control ends.

In step S610 in FIG. 6, the registration section 502 determines whether there is an indicator that has not yet been displayed. The registration section 502 confirms whether all the indicators 411 to 415 illustrated in FIG. 4C are displayed and determines whether there is an indicator that has not yet been displayed.

In step S610 in FIG. 6, if the registration section 502 determines that there is an indicator that has not yet been displayed (YES in step S610), the processing returns to step S605.

In step S605 in FIG. 6, the registration section 502 displays on the display device 214 a next indicator among the indicators that have not yet been displayed. For example, after the indicator 411 illustrated in FIG. 4C is displayed, the registration section 502 displays the indicator 412 as the next indicator on the display device 214. In this manner, the registration section 502 selects the indicators 411 to 415 in numerical order and displays the selected indicators 411 to 415 on the display device 214. If the process of step S605 ends, the processing proceeds to step S606.

In step S610 in FIG. 6, if the registration section 502 determines that an indicator that has not yet been displayed is absent (NO in step S609), the processing proceeds to step S611.

In step S611 in FIG. 6, the registration section 502 saves and registers the obtained information in the registered identification information table 520, the first authentication registered data table 530, and the second authentication registered data table 540 of the registered data management section 503. Specifically, the person IDs in the three tables 520 to 540 illustrated in FIGS. 5B to 5D are IDs for obtaining relations between the tables 520 to 540, and therefore, the value of the same ID is used in the three tables 520 to 540. Specifically, the registration section 502 adds the name of the identification information obtained in step S601 in FIG. 6 to the registered identification information table 520 illustrated in FIG. 5B and registers the name. The registration section 502 also separately registers the feature vector obtained in step S606 in FIG. 6 and the eye image and the position of the indicator corresponding to the feature vector in the first authentication registered data table 530 illustrated in FIG. 5C and the second authentication registered data table 540 illustrated in FIG. 5D. The method for separately registering the information is as follows.

In a first authentication process based on the first authentication registered data table 530 illustrated in FIG. 5C, an indicator is displayed on the display device 214, and the authentication is performed based on an eye image when the user views the indicator. Thus, only a feature extraction vector of the indicator displayed at this time is registered as a feature vector for the registration for the first authentication in the first authentication registered data table 530 illustrated in FIG. 5C. In the present embodiment, in the first authentication registered data table 530 illustrated in FIG. 5C, a feature vector 1 obtained when the indicator 411 illustrated in FIG. 4C is displayed is registered.

In a second authentication process based on the second authentication registered data table 540 illustrated in FIG. 5D, an indicator is not displayed because an object image captured by the imaging element 211 is displayed on the display device 214. Thus, it is not known where on the display device 214 the user is to gaze. Accordingly, in the present embodiment, in the second authentication registered data table 540 illustrated in FIG. 5D, all feature vectors 1 to 5 obtained when the indicators 411 to 415 illustrated in FIG. 4C are displayed are registered.

Next, in step S612 in FIG. 6, the registration section 502 performs display notifying the user that the registration is completed on the touch panel (the operation member 123) or the display device 214.

If the process of step S612 in FIG. 6 ends, the processing of the flowchart in FIG. 6 ends. The processing of the flowchart in FIG. 6 is trapped in an infinite loop where the processing does not end unless it is determined in step S606 that the acquisition of an eye image is successful. Thus, for example, it is desirable to employ a configuration in which if a failure is observed a predetermined number of times, the processing is suspended. The present disclosure is not limited to this configuration, and it is desirable to appropriately add processing in response to an abnormal case.

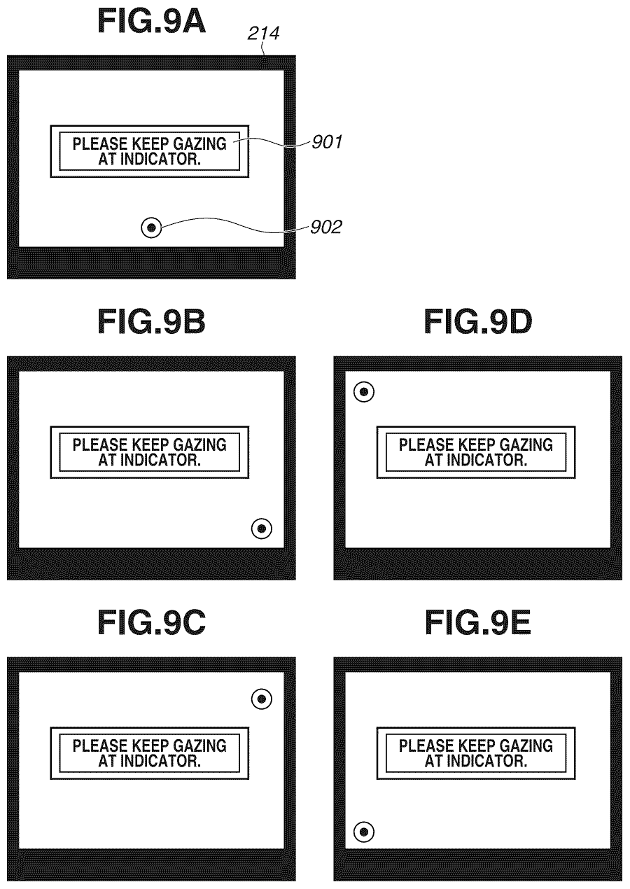

The information displayed in step S604 by the information presentation section 510 changes according to the following authentication type. For example, as illustrated in FIG. 9A, a marker 902 is displayed on the display device 214 in the viewfinder, and message display 901 is performed to instruct the user to gaze at the marker 902. The user is caused to gaze at the marker 902, whereby it is possible to fix the line of sight of the user and capture an image at the timing when the motion of the eyeball is stable. The position of the marker 902 is moved, whereby it is possible to capture the patterns of a plurality of eye images. When registered image for the first authentication, the UI display is changed, by the position of the marker 902 in FIG. 9A indicating the position where the eyeball position is in front when an eyeball imaging camera captures the eyeball, so that an eye image satisfying a criterion 1 can be acquired. Similarly, when a registered image for the second authentication is registered, the UI display is displayed by continuously changing the UI display, whereby the UI display is switched every certain time so that eye images satisfying a criterion 2 can be acquired as illustrated in FIGS. 9B to 9E. The display positions of the marker 902 in FIGS. 9B to 9E are positions suitable for guiding the eyeball to eyeball positions satisfying the criterion 2. The line-of-sight guidance process illustrated in FIGS. 9A to 9E may be performed simultaneously with a calibration process on a line-of-sight detection function.

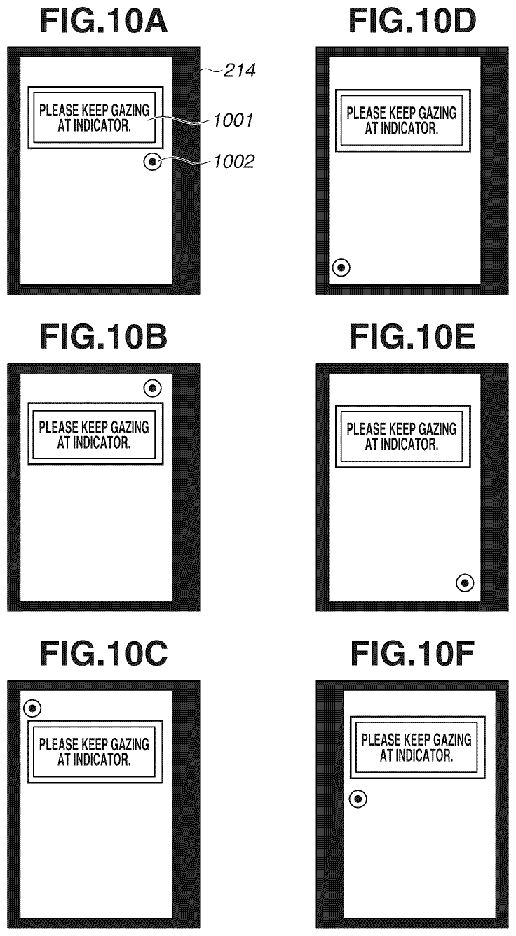

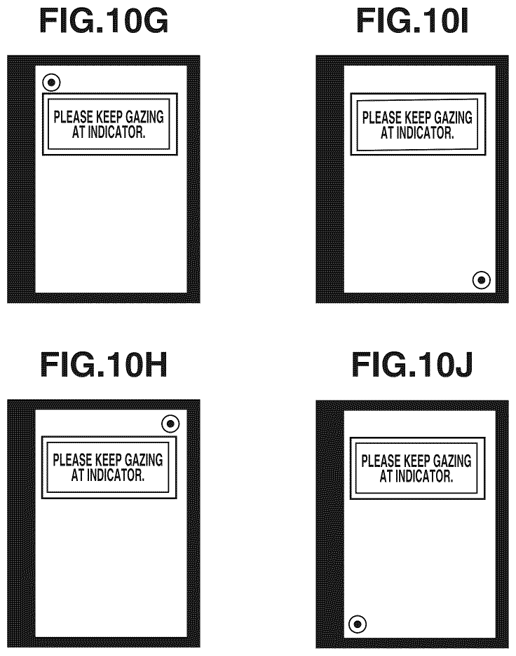

On the assumption of a case where an image is captured by holding the camera in a portrait position, it is also necessary to register an image in the state where the camera is held in the portrait position. For example, as illustrated in FIGS. 10A to 10J, display suitable for holding the camera in the portrait position may be performed. A message 1001 and a marker 1002 corresponding to holding the camera in the portrait position are displayed on the display device 214.

When a registered image for the first authentication is registered, the eyeball is guided as illustrated in FIGS. 10A and 10F so that the user can capture an eye image corresponding to the criterion 1. Additionally, when a registered image for the second authentication is registered, the eyeball is guided by changing the UI display as illustrated in FIGS. 10B to 10E and FIGS. 10G to 10J so that the eyeball is at eyeball positions where eye images satisfying the criterion 2 can be captured.

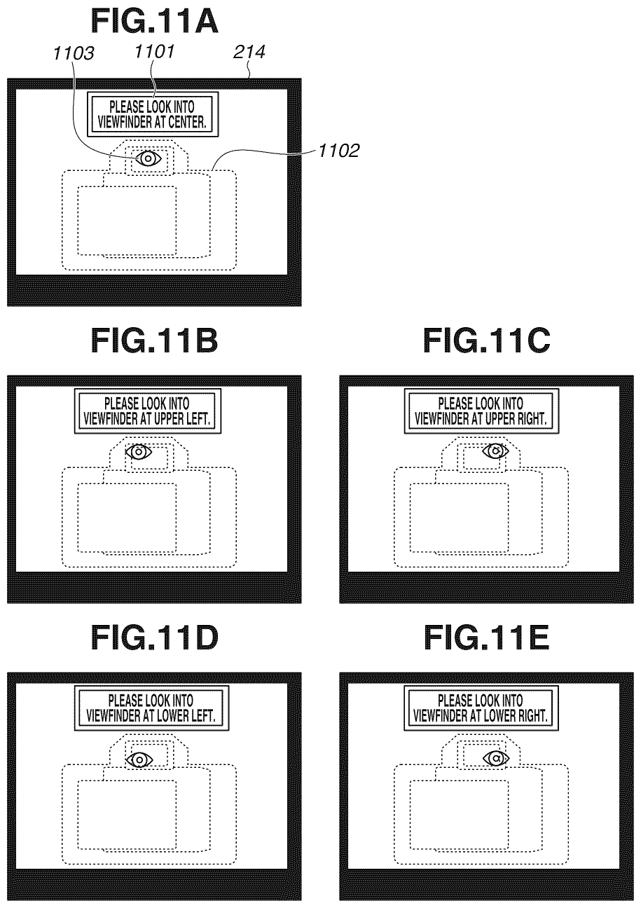

Instead of the method for guiding the line of sight of the user as illustrated in FIGS. 9A to 9E and 10A to 10J, for example, a method for guiding the eye proximity position of the user as illustrated in FIGS. 11A to 11E may be used. When a registered image for the first authentication is registered, illustrations 1102 and 1103 guiding the eye proximity position with a message 1101 so that the eye proximity position is the center of the viewfinder as illustrated in FIG. 11A are displayed on the display device 214. Additionally, when a registered image for the second authentication is registered, the positional relationship between the illustration 1102 representing the camera and the illustration 1103 representing the eye in FIGS. 11B to 11E is shifted, thereby guiding the eye proximity position to satisfy the second criterion.

As described above, when a registered image to be used for the first authentication or the second authentication is registered, a UI to be displayed is determined according to the first criterion or the second criterion, whereby it is possible to acquire a registered image so that a change in visibility between the registered image and an authentication image is small.

### <First Variation of First Embodiment>

In the first embodiment, an example has been described where a registered image is registered using an eye image when the user looks into the viewfinder (the eyepiece lens 122). Specifically, using criteria based on the distance of the pupil center position in an eye image obtained when the user looks into the viewfinder, it is determined whether the eye image can be registered. The present disclosure, however, is not limited to this. An image may be registered using other criteria.

Examples of the criteria are described below.

For example, based on the detection of a prescribed number or more of infrared light reflection areas from a pupil area or an iris area, criteria to be used for the first authentication and the second authentication may be set. First, a plurality of devices that emit infrared light are installed in advance in the viewfinder of the camera. Next, an eye image is captured using an infrared camera, thereby acquiring an image in which infrared light reflection areas are present on a pupil area or an iris area. Next, the infrared light reflection areas are detected from the acquired image.

Lastly, only if the number of detected infrared light reflection areas is greater than or equal to a threshold, the image is registered. For example, the threshold may be set to 10 for the first criterion, and the threshold may be set to 5 for the second criterion.

Alternatively, the condition that a line-of-sight direction is a predetermined direction may be used. For example, a line-of-sight direction may be classified into nine types (eight directions, namely up, down, left, right, and diagonal directions, and a front direction), and images having line-of-sight directions of the respective nine types may each be registered. At this time, it may be determined that an image in which the degree of coincidence between a line-of-sight direction determined in advance and an acquired line-of-sight direction is high satisfies a criterion. At this time, the degree of coincidence set as the first criterion is higher than the degree of coincidence set as the second criterion. The criterion may be set as a predetermined range instead of the degree of coincidence. A description is given on the assumption that at this time, there is a relationship where a range set as the second criterion includes a range set as the first criterion.

As yet another example, the second criterion may be that “the difference in feature amount from an image satisfying the first criterion is within a certain range”. First, the registration of only an image satisfying the first criterion is completed.

Next, regarding subsequent input images, the image features of the already registered image and each input image may be compared with each other, and only if the difference in features between the images is within a certain range, it may be determined that the second criterion is satisfied. As the image features to be used, for example, the image features and the difference between the features to be used in an authentication process may be used.

As yet another example, “variations of a pupil diameter” may be used. For example, while a generally used pupil diameter size may be registered as the first criterion, there is a method for using a criterion for registering a plurality of variations of a pupil diameter as the second criterion. In a scene where the second authentication is used, there is a possibility that the environment changes at an imaging site. Thus, it is necessary to increase variations of a registered image so that the authentication is likely to be successful in a short time in a variety of environments such as a bright outdoor place, a dark indoor place, and the like.

### <Second Variation of First Embodiment>

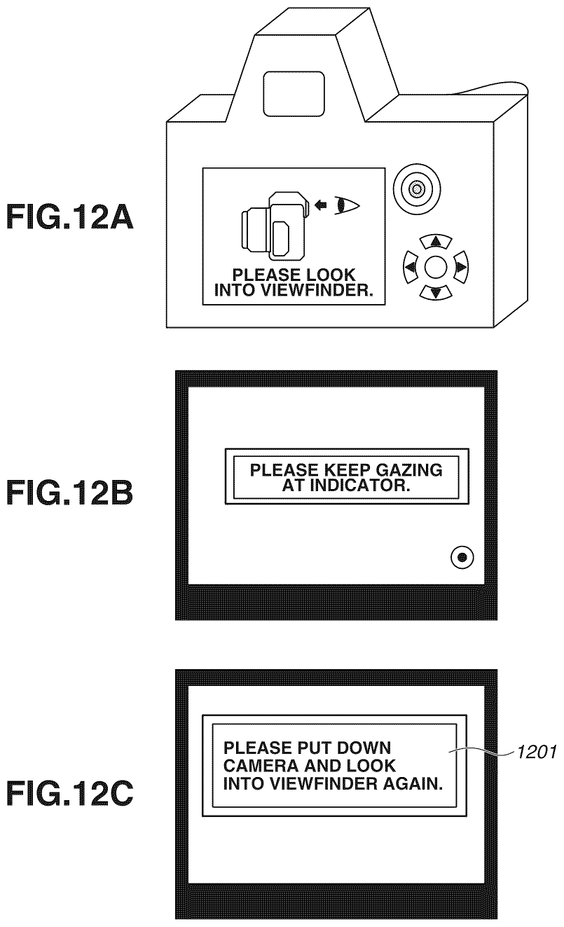

In the first embodiment, a method for moving a marker as illustrated in FIGS. 9A to 9E and 10A to 10J and guiding the line of sight in the state where the user looks into the viewfinder has been illustrated. However, the UI display reflecting the use state of the actual user may be performed. For example, the UI display instructs the user to perform an action of separating their eye from the viewfinder and looking into the viewfinder again every time the position of a marker is changed. Specifically, after any one type of the display of the marker 1002 illustrated in FIGS. 10A to 10J is displayed as illustrated in FIG. 12B, a message 1201 “please put down camera and look into viewfinder again” is displayed on the display device 214 as illustrated in FIG. 12C. If the eye proximity sensor 221 detects that the user separates their eye from the viewfinder, a UI in FIG. 12A is displayed on the touch panel (the operation member 123), thereby instructing the user to look into the viewfinder. If the eye proximity sensor 221 detects that the user places their eye in proximity to the viewfinder, next, a UI obtained by changing the marker position in FIG. 12B is displayed. At this time, the marker position is randomly displayed in order among the marker positions illustrated in FIGS. 9A to 9E or illustrated in FIGS. 10A to 10J if registration is performed in the portrait position. By using the method according to a second variation, it is possible to acquire a registered image also including variation in the eye proximity operation of the actual user. Thus, it is possible to expect the effect of improving the authentication accuracy in use.

### <Third Variation of First Embodiment>

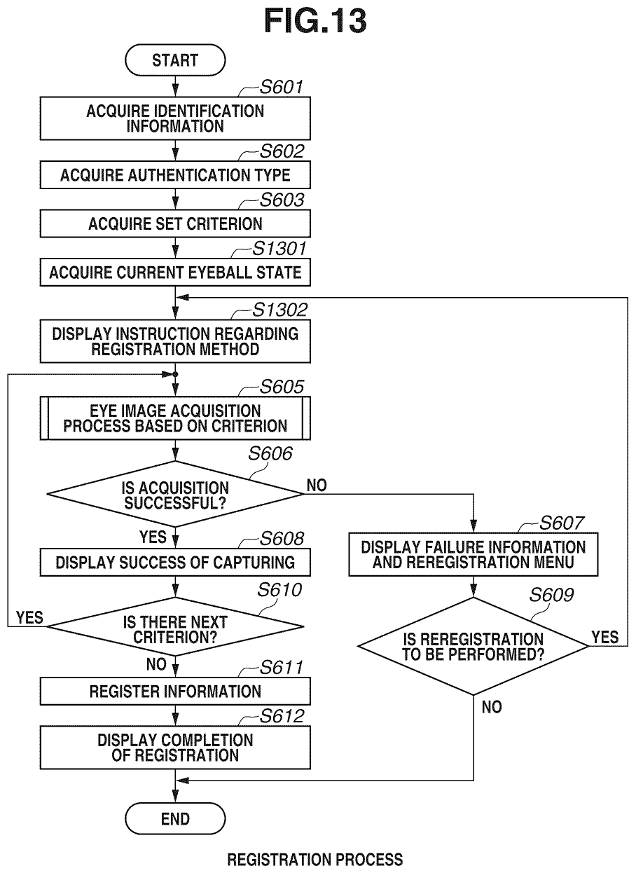

As illustrated in FIG. 6, when the UI display for an eye image in the registration process is determined, a method for determining the UI display based not only on a criterion but also on the eyeball state of the user while the eye is in proximity may be used. FIG. 13 is a flowchart illustrating the flow of processing according to a third variation. The same processes as those in FIG. 6 according to the first embodiment are designated by the same reference numbers. Process steps that differ from those illustrated in FIG. 6 are described below.

In step S1301, the registration section 502 acquires the current eyeball state. A case is described where line-of-sight information is acquired as the eyeball state.

In step S1302, the information presentation section 510 displays a UI based on the criterion acquired in step S603 and the eyeball state acquired in step S1301.

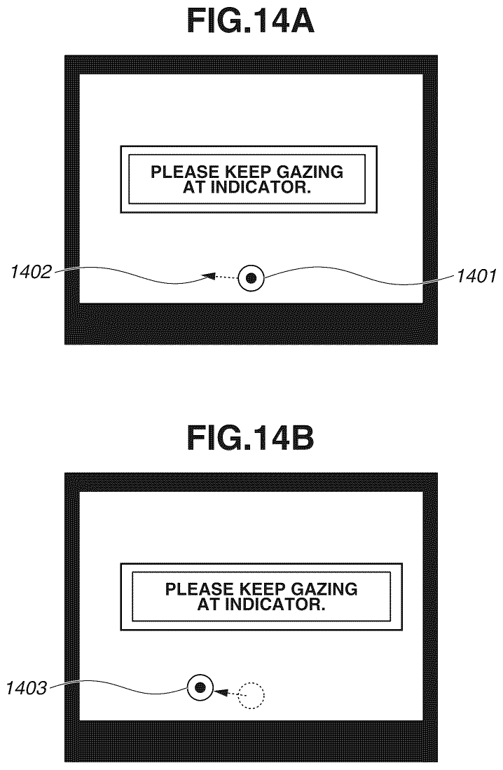

If the line of sight is acquired as the eyeball state, a marker position at which the user is requested to gaze is calculated based on the difference between the current line of sight and a line-of-sight position satisfying the criterion. As illustrated in FIGS. 14A and 14B, a marker position moves from a marker 1401 at which the user is gazing in a line-of-sight position direction 1402 satisfying the criterion. The line of sight of the user is guided according to the movement of the marker position, whereby it is possible to bring the line of sight of the user closer to a target position. Thus, it is possible to expect an improvement in the quality of a registered image.

### <Fourth Variation of First Embodiment>

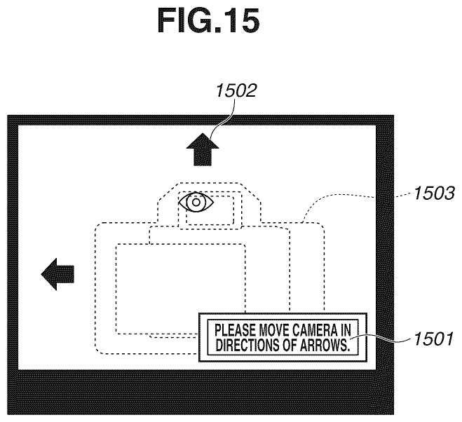

Although in the third variation, a description has been given on the assumption that the eyeball position may be acquired as the current eyeball state, the present disclosure is not limited to this. For example, an eyeball is detected in an acquired eye image using the eyeball detection method described in the first embodiment. Further, if the coordinates of the center of the eyeball are current eyeball position coordinates C1, and in a case where the criteria illustrated in FIG. 7A are used, it is possible to calculate the direction in which the difference between criterion coordinates that are being used among the criterion coordinates (points) P0 to P4 and the current eyeball position coordinates C1 is small. As illustrated in FIG. 15, a message 1501 guiding the eye proximity position of the user in the obtained direction, an illustration 1503 indicating the eye proximity position, and an arrow 1502 are displayed, whereby it is possible to bring the line of sight of the user closer to a target eyeball position.

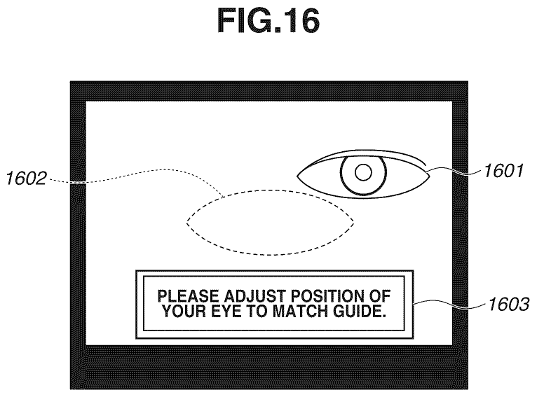

As illustrated in FIG. 16, an icon 1601 indicating the current eyeball position may be displayed in real time on the display device 214. A message 1603 giving an instruction to adjust the eye position to a guide, and a guide 1602 indicating an eyeball position where the difference between the current eyeball position coordinates and the criterion coordinates is smallest may be displayed on the display device 214. As a result, the user can intuitively adjust the eye proximity position to a position suitable for satisfying a criterion.

### <Fifth Variation of First Embodiment>

As the current eyeball state, not only the line of sight but also the eye proximity distance or the eye proximity angle may be acquired. As the eye proximity distance, the distance between the camera and the eyeball of the user is calculated using the output value of the eye proximity sensor 221. The eye proximity distance or the eye proximity angle may be calculated from an acquired eye image by image processing. If the size or the visibility of an iris area in an eye image is used as a criterion, a change in the size of an area occupied by the eyeball or the size of an iris area in an image according to the eye proximity distance or the eye proximity angle influences the result of area detection.

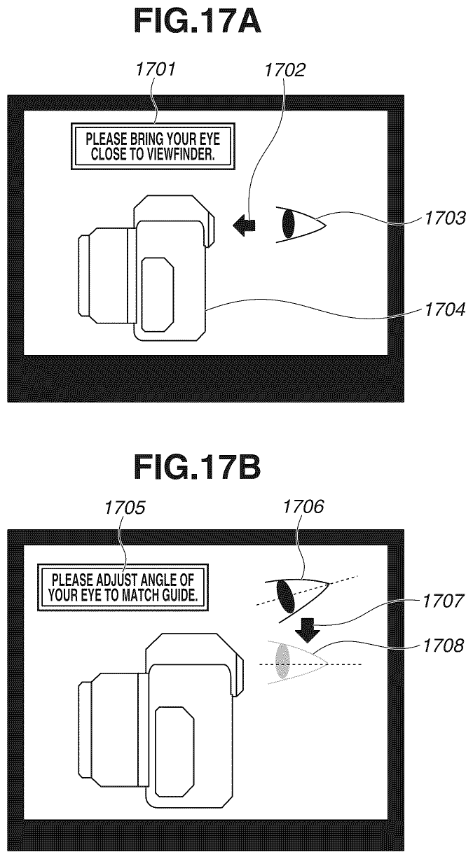

For example, if a criterion is “the condition that a prescribed number or more of infrared light reflection areas can be detected from a pupil area or an iris area” or “the degree of opening of the eyelid,” the state of the eyeball changes. At this time, as illustrated in FIG. 17A, a message 1701 guiding the eye proximity distance of the user and an arrow 1702 indicating the direction in which the eye proximity distance is adjusted between an illustration 1703 of the eyeball of the user and an illustration 1704 of the camera are displayed. As illustrated in FIG. 17B, a message 1705 urging the user to adjust the eye proximity angle is displayed. Further, an illustration 1706 indicating the current eye proximity angle of the user, an illustration 1708 indicating an eye proximity angle for satisfying the criterion, and an arrow 1707 indicating the direction in which the eye proximity angle is adjusted are displayed, whereby it is possible to adjust the eye proximity angle.

### <Sixth Variation of First Embodiment>

In the examples of the UI displays in FIGS. 9A to 9E, 10A to 10J, 11A to 11E, 12A to 12C, 14A and 14B, 15, 16, and 17A and 17B for guiding the user to satisfy the criteria that are illustrated in the present embodiment, the instructions may be given not by the method for displaying the UIs on the display device 214, but by voice guidance. The voice guidance is reproduced by the loudspeaker 220. As the contents of the voice guidance, the messages to be displayed on the display device 214 may be read. In a case where an arrow is displayed on the display device 214, words expressing the direction of the arrow are reproduced as voice guidance, whereby it is possible to expect an improvement in user accessibility.

### Second Embodiment

In the first embodiment, as illustrated in FIGS. 9A to 9E to FIGS. 17A and 17B, in the eye image acquisition process for acquiring an eye image to be used as a registered image, the line of sight, the eye proximity position, or the like of the user is guided by the UI display, and at the timing when an eye image satisfying the criterion is obtained in step S605, the eye image is acquired. In a second embodiment, a case is described where the user himself or herself determines the timing when an eye image is acquired.

An imaging apparatus according to the present embodiment has the hardware configurations illustrated in FIGS. 1, 2, and 3. The imaging apparatus according to the present embodiment is a camera having the functional block configuration illustrated in FIG. 5A. Further, the flow of the registration process illustrated in FIG. 6 in the first embodiment is similar to that in the present embodiment except that in the eye image acquisition process, processing different from that in the first embodiment is performed. Accordingly, the differences between the present embodiment and the first embodiment are mainly described, and similar portions are not described below. Portions corresponding to those in the first embodiment are designated by the same reference numbers in the description.

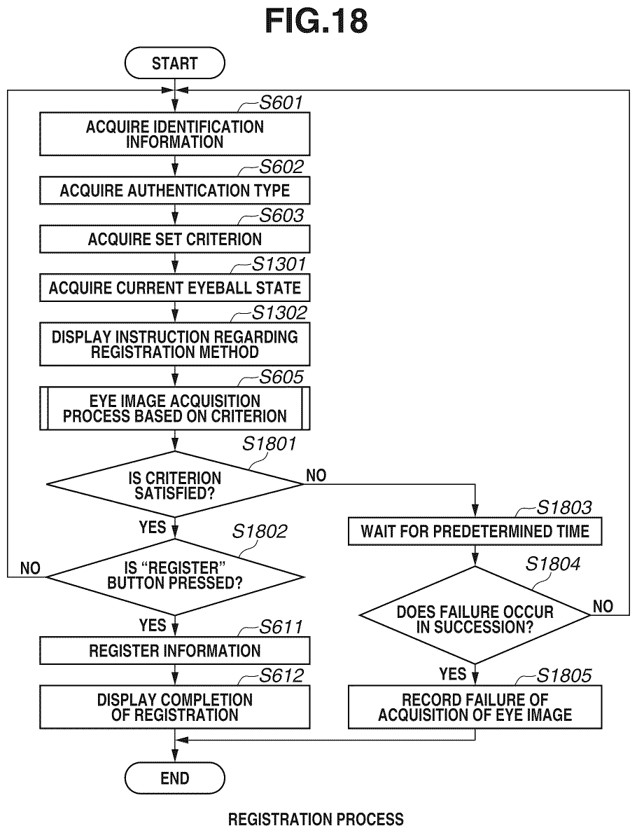

FIG. 18 illustrates an eye image acquisition process according to the present embodiment. Basically, the eye image acquisition process is similar to the process illustrated in FIG. 13 except that the processes of steps S1801 to S1805 in FIG. 18 are added.

In step S1301 in FIG. 18, the registration section 502 acquires the current eyeball state, calculates from the acquired current eyeball state an eyeball state score indicating the degree of how much of the criterion is satisfied, and displays the eyeball state score. For example, in the case of the criteria illustrated in FIG. 7A according to the first embodiment, if the eyeball state score is S, and the Manhattan distance between the coordinates of the acquired current eyeball state and the criterion coordinates is D, the eyeball state score S is calculated based on the following function f.

$$S = f ( D )$$

The function f is a function that is great if the distance D is close to 0, and decreases in proportion to the distance D. For ease of understanding, the score S may be normalized to be represented in the range of 0 to 100. The function to be used is not limited to the above so long as its qualitative properties are the same. The method for obtaining the score S is not limited to the technique using the distance D. The score S may be obtained by another method so long as the score S is an indicator indicating whether the image is suitable for a registration image for eyeball authentication.

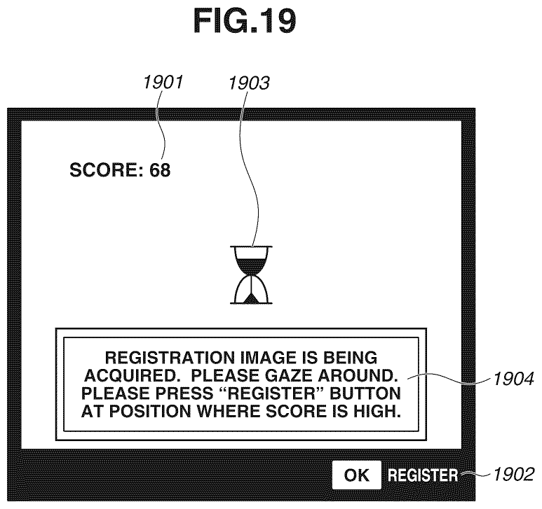

As illustrated in FIG. 19, an eyeball state score 1901 calculated during the eye image acquisition process for acquiring an eye image of the user is displayed in real time on the display device 214. The above display is performed, whereby the user can intuitively understand how to move the eyeball from the current position of the eyeball to register an appropriate image satisfying the criterion. Thus, it is possible to expect an improvement in the quality of a registered image.

In step S1801, if it is determined that the criterion is satisfied (YES in step S1801), then as illustrated in FIG. 19, the information presentation section 510 displays a message 1904 urging the user to press a “register” button 1902 at any timing, and the processing proceeds to step S1802. If it is not determined that the criterion is satisfied (NO in step S1801), the processing proceeds to step S1803.

In step S1802, it is determined whether the user presses the “register” button 1902. If the “register” button 1902 is pressed (YES in step S1802), the processing proceeds to step S611. If the “register” button 1902 is not pressed (NO in step S1802), the processing returns to step S601. By this flow, it is possible to acquire an eye image at any timing desired by the user.

In step S1803, the eye image acquisition section 501 performs the process of waiting for a predetermined amount of time, such as several hundreds of milliseconds. If an eye image to be obtained changes by this process and the determination based on the criterion is successful, it is determined that the criterion is satisfied. Then, the processing proceeds to step S1802.

In step S1804, the eye image acquisition section 501 determines whether the acquisition of an eye image fails in succession. The “failure” means a case where it is determined in step S1801 that a suitable image is not acquired. If the acquisition of an eye image fails the number of times determined in advance in succession (YES in step S1804), the processing proceeds to step S1805. If not (NO in step S1804), the processing returns to step S601.

In step S1805, the eye image acquisition section 501 records the failure of the acquisition of an eye image using a flag or the like.

The color of the eyeball state score 1901 or an icon 1903 may be changed according to the score.

The present disclosure is not limited to the above example. The color of a portion where the user is caused to intuitively recognize the level of the score in the UI may be changed. For example, the position of the current line of sight or the current eye proximity position may be displayed as a marker in the UI, and the color of the marker may be changed according to the score.

In the first embodiment, an eye image satisfying a criterion is automatically acquired based on whether the eye image satisfies the criterion. In this case, the burden on the user is small, and it is possible to shorten the time taken for the acquisition. However, since an eye image is acquired at the timing when the determination is made and the criterion is satisfied, an eye image is not necessarily acquired at the moment when the criterion is most satisfied. Accordingly, in the present embodiment, the criterion satisfaction degree of an eye image is displayed as a score in real time on the display device 214. The above display process is performed, whereby the user performing registration himself or herself can adjust the eyeball state such as the line of sight or the eye proximity position that enables the capturing of an eye image that makes the score high. Further, the user captures an image by selecting the timing when the score is high, whereby it is possible to register an eyeball image more suitable for authentication as a registered image.

### <First Variation of Second Embodiment>

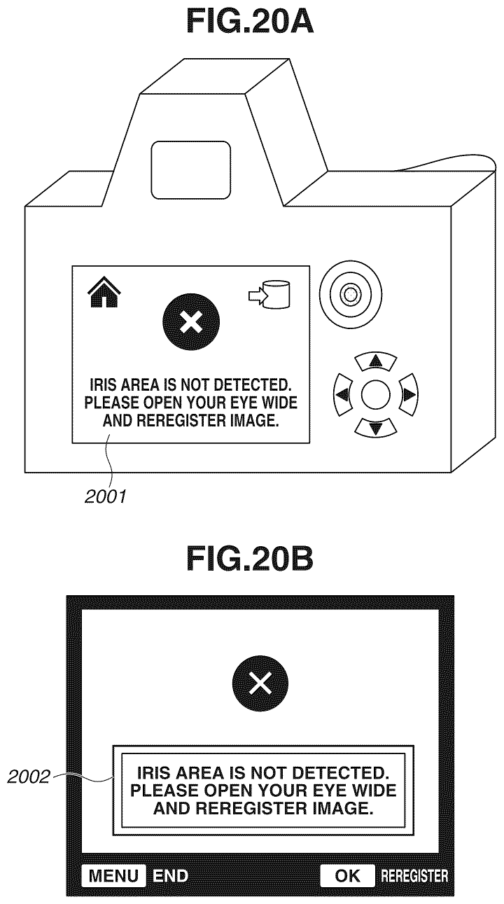

In the second embodiment, the failure information may be displayed as in step S607, and the failure information displayed in step S607 may include the cause of the failure. For example, the eyeball state is scored based on the plurality of indicators. Further, an eye image acquisition process for acquiring an eye image when all the indicators satisfy the criterion value is performed. At this time, regarding the indicator having the lowest score when the registration fails, cause information or improvement advice is presented to the user as illustrated in FIGS. 20A and 20B when the failure information is displayed. Messages 2001 and 2002 are displayed on the touch panel 103 or the display device 214.

If the cause of the failure is due to a factor other than the state of the eyeball, information regarding the factor may be displayed. For example, if an iris area of an eye image is hidden by unnecessary reflection because the user wears eyeglasses, a display message “please take off your eyeglasses” is displayed. In the case of an unsharp eye image that is dark overall, a display message “please move to a bright place” as improvement advice is displayed. If the attachment of a drop of water to the eyepiece lens 102 or the fogging of the eyepiece lens 102 is detected, a display message “please wipe the eyepiece lens” or the like may be displayed, thereby urging the user to deal with the failure.

As illustrated in a first variation, the user is correctly informed of the cause of the failure of the acquisition of an eye image and urged to deal with the failure, whereby it is possible to ensure the quality of an eye image that should be registered by correcting the cause of the failure.

### <Second Variation of Second Embodiment>

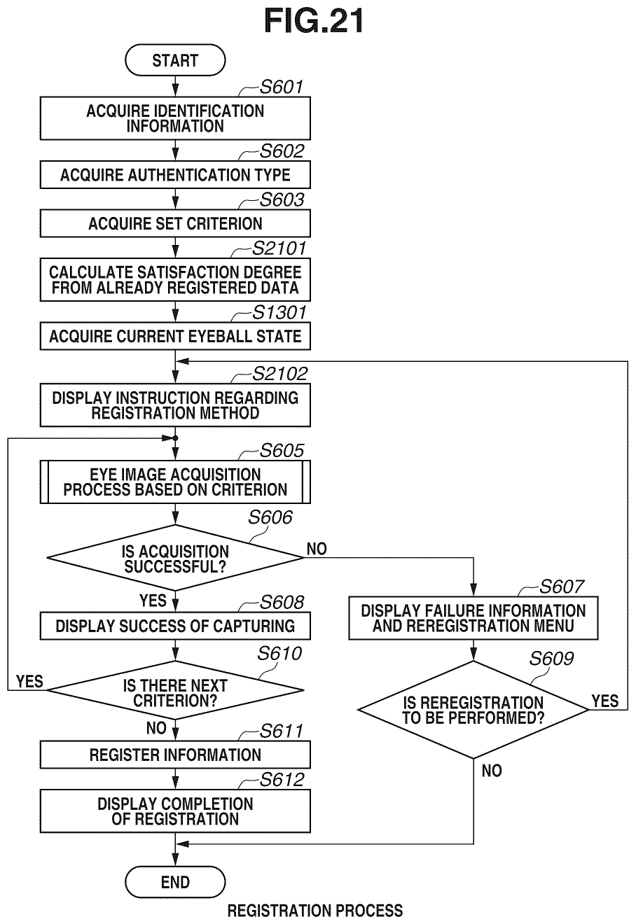

FIG. 21 is a flowchart illustrating an example of the flow of processing according to a second variation of the second embodiment. The flow of the basic processing is similar to that in FIG. 13 except that step S2101 is added in FIG. 21, and therefore, the process of step S1302 in FIG. 13 is changed to that of step S2102. Consequently, in the present variation, it is possible to determine a UI to be displayed, taking into account already registered data. Thus, it is possible to solve the deviation, excess, or deficiency of registered data.

In step S2101, the registration section 502 calculates a satisfaction degree (satisfaction degree information) based on already registered data. The satisfaction degree is a degree indicating how much data satisfying a criterion is collected. For example, in a case where a plurality of images are registered, the number of registered images satisfying each criterion is used as the satisfaction degree. The average value, the maximum value, the minimum value, and the like of the satisfaction degree may be calculated based on the eyeball state score with respect to each criterion and used.

In step S2102, the registration section 502 determines a UI to be displayed, based on the criterion, the eyeball state, and the satisfaction degree.

For example, in a case where a criterion for an eyeball position is used, the satisfaction degree is calculated based on already registered data, and the direction of an eyeball position having a low satisfaction degree is calculated. Using information regarding the calculated direction and the current eyeball position, display for adjusting the eyeball position is presented to the user. Specifically, the display illustrated in FIGS. 17A and 17B is performed. Similarly, in a case where a criterion for a line-of-sight direction is used, the satisfaction degree regarding a line-of-sight direction may be obtained based on already registered data. Using line-of-sight information acquired from the current eyeball state, a line-of-sight guidance UI as illustrated in FIG. 16 may be displayed.

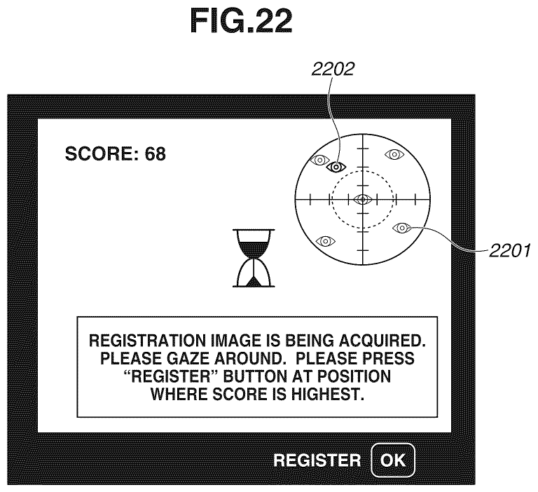

For example, information regarding an eyeball position having a high satisfaction degree may be displayed based on already registered data on the display device 214. As illustrated in FIG. 22, an already registered eyeball position 2201 and a current eyeball position 2202 are displayed. The above display is performed, whereby the user himself or herself can capture an image by recognizing the position where the eyeball position has a high satisfaction degree and the position where the eyeball position has a low satisfaction degree and aiming at the position where the satisfaction degree is insufficient. Variations of an eyeball position to be registered increase, and it is possible to expect an improvement in the authentication accuracy.

### Other Embodiments

The present disclosure can also be achieved by the process of supplying a program for achieving one or more functions of the above embodiments to a system or an apparatus via a network or a storage medium, and of causing one or more processors in a computer of the system or the apparatus to read and execute the program. The present disclosure can also be achieved by a circuit (e.g., an application-specific integrated circuit (ASIC)) for achieving the one or more functions.

This program and a computer-readable storage medium storing the program are included in the present disclosure. The present disclosure can employ an embodiment as, for example, the above system, apparatus, method, program, or storage medium. For example, the present disclosure may be applied to a system including a plurality of devices, or it may be applied to an apparatus composed of a single device.

All the above embodiments of the present disclosure merely illustrate specific examples for carrying out the present disclosure, and the technical scope of the present disclosure should not be interpreted in a limited manner based on these embodiments. That is, the present disclosure can be carried out in various ways without departing from the technical idea or the main feature of the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-179623, filed Oct. 15, 2024, the entirety of which is incorporated herein by reference.

1. An image processing apparatus comprising:
at least one processor; and
at least one memory having stored thereon instructions which, when executed by the at least one processor, cause the image processing apparatus to:
capture an eyeball image of a user;
determine whether a captured first eyeball image satisfies a first condition;
determine whether a captured second eyeball image satisfies a second condition;
in a case where a user operation for registering the eyeball image is acquired, present first presentation information to the user in a case where the first condition is satisfied, and present second presentation information to the user in a case where the second condition is satisfied;
in a case where it is determined that the first eyeball image satisfies the first condition, perform control to register at least one of the first eyeball image or an image feature that can be acquired from the first eyeball image; and
in a case where it is determined that the second eyeball image satisfies the second condition, perform control to register at least one of the second eyeball image or an image feature that can be acquired from the second eyeball image.

2. The image processing apparatus according to claim 1,
wherein the user is authenticated using the registered first eyeball image or the registered image feature that can be acquired from the first eyeball image, and
wherein the user is authenticated using the registered second eyeball image or the registered image feature that can be acquired from the second eyeball image.

3. The image processing apparatus according to claim 1,
wherein, in a case where a distance between a position of an eye in the first eyeball image and a predetermined position in the first eyeball image is less than or equal to a first distance, it is determined that the first condition is satisfied,
wherein, in a case where a distance between a position of an eye in the second eyeball image and the predetermined position in the second eyeball image is less than or equal to a second distance, it is determined that the second condition is satisfied, and
wherein the first distance is shorter than the second distance.

4. The image processing apparatus according to claim 1,
wherein, in a case where a direction of a line of sight in the first eyeball image coincides with a predetermined direction set in advance within a first range, it is determined that the first condition is satisfied,
wherein, in a case where a direction of a line of sight in the second eyeball image coincides with the predetermined direction set in advance within a second range, it is determined that the second condition is satisfied, and
wherein the first range is included within the second range.

5. The image processing apparatus according to claim 1, further comprising:
an information presentation unit that is at least one of a display device in a viewfinder or a back surface display, and
wherein the first presentation information and the second presentation information are information for bringing any of a degree of opening of an eyelid, an eye proximity position, an eye proximity angle, an eye proximity distance, or a line of sight of the user into a predetermined state.

6. The image processing apparatus according to claim 5,
wherein the information for bringing the line of sight of the user into the predetermined state is a marker display displayed on the information presentation unit, and
wherein a position of the marker display is presented based on the first condition or the second condition.

7. The image processing apparatus according to claim 5,
wherein information regarding a state of an eyeball of the user is acquired, and
wherein the first presentation information or the second presentation information is determined based on the first condition or the second condition and the state of the eyeball.

8. The image processing apparatus according to claim 7, further comprising a line-of-sight sensor configured to acquire information regarding the state,
wherein the first presentation information or the second presentation information is determined based on a line-of-sight direction of the eyeball of the user obtained by the line-of-sight sensor.

9. The image processing apparatus according to claim 7, further comprising an eye proximity sensor configured to acquire information regarding the state,
wherein the first presentation information or the second presentation information is determined based on an eye proximity distance between the eyeball of the user obtained by the eye proximity sensor and an imaging unit.

10. The image processing apparatus according to claim 7,
wherein the information regarding the state of the eyeball of the user is image information obtained by performing image processing on the eyeball image, and
wherein the first presentation information or the second presentation information is determined based on the image information.

11. The image processing apparatus according to claim 7,
wherein a numerical value indicating a degree of how much of the first condition or the second condition is satisfied is calculated based on at least one or more pieces of information regarding a degree of opening of an eyelid, a line of sight, an eye proximity distance, or image information obtained by performing image processing on the eyeball image, and
wherein at least one or more pieces of information regarding the numerical value or a plurality of colors are presented to the user.

12. The image processing apparatus according to claim 1, wherein, in a case where it is determined that the first condition or the second condition is not satisfied, third presentation information regarding a cause of the determination that the first condition or the second condition is not satisfied is presented.

13. The image processing apparatus according to claim 1
wherein registered data is managed, and
the first presentation information or the second presentation information is determined based on information regarding a satisfaction degree obtained based on the registered data.

14. The image processing apparatus according to claim 13, wherein the first presentation information or the second presentation information includes information regarding a position of an eye having a high satisfaction degree obtained based on the information regarding the satisfaction degree.

15. The image processing apparatus according to claim 13, wherein the first presentation information or the second presentation information includes information regarding a position of an eye having a low satisfaction degree or information regarding a line-of-sight direction.

16. The image processing apparatus according to claim 1, wherein sounds of the first presentation information and the second presentation information are output.

17. A control method for controlling an image processing apparatus, the control method comprising:
capturing an eyeball image of a user;
determining whether a captured first eyeball image satisfies a first condition;
determining whether a captured second eyeball image satisfies a second condition;
in a case where a user operation for registering the eyeball image is acquired, presenting first presentation information to the user in a case where the first condition is satisfied, and presenting second presentation information to the user in a case where the second condition is satisfied;
in a case where it is determined that the first eyeball image satisfies the first condition, performing control to register at least one of the first eyeball image or an image feature that can be acquired from the first eyeball image; and
in a case where it is determined that the second eyeball image satisfies the second condition, performing control to register at least one of the second eyeball image or an image feature that can be acquired from the second eyeball image.

18. A non-transitory computer-readable storage medium storing a program for causing a computer to execute the steps of the control method for controlling the image processing apparatus according to claim 17.
